(19) United States
(12) Patent Application Publication
(10) Pub. No.: US 2018/0189910 A1
(43) Pub. Date: Jul. 5, 2018

(54) SYSTEM AND METHOD FOR MAINTAINING DIGITAL PRESENCE OF THE DECEASED

(71) Applicant: HIGHLANDERS, LLC, New York, NY (US)

(72) Inventors: Matteo Deninno, New York, NY (US); Francesca Romana Cassisi, New York, NY (US)

(21) Appl. No.: 15/423,127

(22) Filed: Feb. 2, 2017

Related U.S. Application Data
(60) Provisional application No. 62/441,637, filed on Jan. 3, 2017.

(51) Int. Cl. G06Q 50/18; G06Q 50/00; G06F 17/30

(52) U.S. Cl. CPC G06Q 50/186; G06F 17/30867; G06Q 50/01

(57) ABSTRACT

A method for maintaining a digital presence of deceased users comprises storing on a server one or more future events, each of the one or more future events including an event identifier, an event trigger, an event status initially set to an inactive status, a stored action, wherein the stored action is an action to be taken by the server when the event is in an active status and when the event trigger occurs, and one or more stored destinations for directing the stored action. The method further comprises receiving at the server a notification to activate the one or more future events, switching the event status of each of the one or more future events to the active status, and executing the one or more future events based on the event trigger associated with each of the one or more future events.

### CROSS-REFERENCE TO RELATED APPLICATIONS

The application claims the benefit of U.S. Provisional Application No. 62/441,637, filed Jan. 3, 2017, and entitled SYSTEM AND METHOD FOR MAINTAINING DIGITAL PRESENCE OF DECEASED, which is incorporated by reference herein in its entirety.

### SUMMARY

In one aspect thereof, a method for maintaining a digital presence of deceased users is provided. The method comprises storing, on a server, user information pertaining to a user, storing on the server one or more future events, each of the one or more future events including an event identifier, an event trigger, wherein the event trigger is a predefined parameter that must occur for a future event to be triggered, an event status initially set to an inactive status, wherein the inactive status indicates that the event will not occur, even if the event trigger occurs, a stored action, wherein the stored action is an action to be taken by the server when the event is in an active status and when the event trigger occurs, and one or more stored destinations for directing the stored action, receiving at the server a notification to activate the one or more future events, switching the event status of each of the one or more future events to the active status, and executing the one or more future events based on the event trigger associated with each of the one or more future events.

In another embodiment, the event trigger is a specified date.

In another embodiment, the event trigger is triggered by analyzing content of web feeds retrieved by the server for pre-defined keywords or phrases.

In another embodiment, the event trigger is triggered by the server receiving a notification of a change in status of a remote device.

In another embodiment, the stored action includes content to be posted on a web-based social network, and formatting parameters for the content.

In another embodiment, the method further comprises determining whether execution of the stored action will result in the content being directed to more than one group of users of the social network, arranging in a list a plurality of unique identifiers in numerical order, each of the unique identifiers being associated with a specific user among the more than one group of users of the social network, selecting, starting from the beginning of the list, a next user identifier in the list, comparing the next user identifier with a user identifier immediately following the next user identifier, determining if the next user identifier and the user identifier immediately following the next user identifier are equal, removing, if the next user identifier and the user identifier immediately following the next user identifier are equal, the immediately following user identifier from the list, determining if the end of the list has been reached, repeating, if the end of the list has not been reached, the selecting, comparing, determining, removing, and determining steps, and directing the content to the user identifiers contained within the list upon execution of the stored action.

In another embodiment, the stored action includes sending a text, email, or phone message to a user.

In another embodiment, the stored action for at least one of the one or more future events includes parameters for altering the status of a remote device.

In another embodiment, the method further comprises assigning the remote device with a unique identifier, storing at the server the unique identifier, storing a device address for the remote device, wherein the device address is addressable over a network, storing a device action specific to the type of device of the remote device, and wherein executing the stored action for the at least one of the one or more future events includes performing the device action to alter the status of the remote device.

In another embodiment, the notification to activate the one or more future events is an electronic transmission received by the server from a user responsible for notifying the server when another user is now deceased.

In another aspect thereof, a system for maintaining a digital presence of deceased users is provided. The system comprises a processor, and a memory coupled to the process, the memory containing computer executable instructions for storing, on a server, user information pertaining to a user, storing on the server one or more future events, each of the one or more future events including an event identifier, an event trigger, wherein the event trigger is a predefined parameter that must occur for a future event to be triggered, an event status initially set to an inactive status, wherein the inactive status indicates that the event will not occur, even if the event trigger occurs, a stored action, wherein the stored action is an action to be taken by the server when the event is in an active status and when the event trigger occurs, and one or more stored destinations for directing the stored action, receiving at the server a notification to activate the one or more future events, switching the event status of each of the one or more future events to the active status, and executing the one or more future events based on the event trigger associated with each of the one or more future events.

In another embodiment, the event trigger is a specified date.

In another embodiment, the event trigger is triggered by analyzing content of web feeds retrieved by the server for pre-defined keywords or phrases.

In another embodiment, the event trigger is triggered by the server receiving a notification of a change in status of a remote device.

In another embodiment, the stored action includes content to be posted on a web-based social network, and formatting parameters for the content.

In another embodiment, the system further comprises instructions for determining whether execution of the stored action will result in the content being directed to more than one group of users of the social network, arranging in a list a plurality of unique identifiers in numerical order, each of the unique identifiers being associated with a specific user among the more than one group of users of the social network, selecting, starting from the beginning of the list, a next user identifier in the list, comparing the next user identifier with a user identifier immediately following the next user identifier, determining if the next user identifier and the user identifier immediately following the next user identifier are equal, removing, if the next user identifier and the user identifier immediately following the next user identifier are equal, the immediately following user identifier from the list, determining if the end of the list has been reached, repeating, if the end of the list has not been reached, the selecting, comparing, determining, removing, and determining steps, and directing the content to the user identifiers contained within the list upon execution of the stored action.

In another embodiment, the stored action includes sending a text, email, or phone message to a user.

In another embodiment, the stored action for at least one of the one or more future events includes parameters for altering the status of a remote device.

In another embodiment, the system further comprises instructions for assigning the remote device with a unique identifier, storing at the server the unique identifier, storing a device address for the remote device, wherein the device address is addressable over a network, storing a device action specific to the type of device of the remote device, and wherein executing the stored action for the at least one of the one or more future events includes performing the device action to alter the status of the remote device.

In another embodiment, the notification to activate the one or more future events is an electronic transmission received by the server from a user responsible for notifying the server when another user is now deceased.

### BRIEF DESCRIPTION OF THE DRAWINGS

For a more complete understanding, reference is now made to the following description taken in conjunction with the accompanying Drawings in which:

FIG. 1 illustrates a diagrammatic view of one embodiment of a digital presence system;

FIG. 2A illustrates a diagrammatic view of one embodiment of a user's inner circles;

FIG. 2B illustrates a diagrammatic view of one embodiment of organizing inner circles for users;

FIG. 3 illustrates a flowchart of one embodiment of a post creation and inner circle feed update process;

FIG. 4 illustrates one embodiment of a post saving process;

FIG. 5 illustrates a flowchart of one embodiment of a user life-event-based future triggered event creation process;

FIG. 6 illustrates a flowchart of one embodiment of an inner circle user based future triggered event creation process;

FIG. 7 illustrates a flowchart of one embodiment of a user interest based future triggered event creation process;

FIG. 8 illustrates a flowchart of one embodiment of a linked device based future triggered event creation process;

FIG. 9 illustrates a flowchart of one embodiment of a calendar or time based future triggered event creation process;

FIG. 10 illustrates a flowchart of one embodiment of a triggered post creation process;

FIG. 11 illustrates a flowchart of one embodiment of a triggered message transmission process;

FIG. 12 illustrates a flowchart of one embodiment of a triggered device status alteration process;

FIG. 13 illustrates a flowchart of one embodiment of a triggered purchasing process;

FIG. 14 illustrates a flowchart of one embodiment of a credits gifting process;

FIG. 15A illustrates one embodiment of a future event creation graphical user interface;

FIG. 15B illustrates another view of the future event creation graphical user interface of FIG. 15A;

FIG. 15C illustrates another view of the future event creation graphical user interface of FIGS. 15A-15B;

FIG. 15D illustrates another view of the future event creation graphical user interface of FIGS. 15A-15C;

FIG. 15E illustrates another view of the future event creation graphical user interface of FIGS. 15A-15D;

FIG. 15F illustrates another view of the future event creation graphical user interface of FIGS. 15A-15E;

FIG. 15G illustrates another view of the future event creation graphical user interface of FIGS. 15A-15F;

FIG. 16 illustrates one embodiment of a social network platform functionality diagram;

FIG. 17 illustrates a flowchart of one embodiment of a legacy contact selection process;

FIG. 18 illustrates a flowchart of one embodiment of a legacy contact initiated deceased status notification process;

FIG. 19 illustrates a diagrammatic view of one embodiment of an event storage and event execution system;

FIG. 20 illustrates a flowchart of one embodiment of a duplicate post avoidance process; and

FIG. 21 illustrates a diagrammatic view of one embodiment of a system device that may be used within the environment described herein.

### DETAILED DESCRIPTION

Referring now to the drawings, wherein like reference numbers are used herein to designate like elements throughout, the various views and embodiments are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

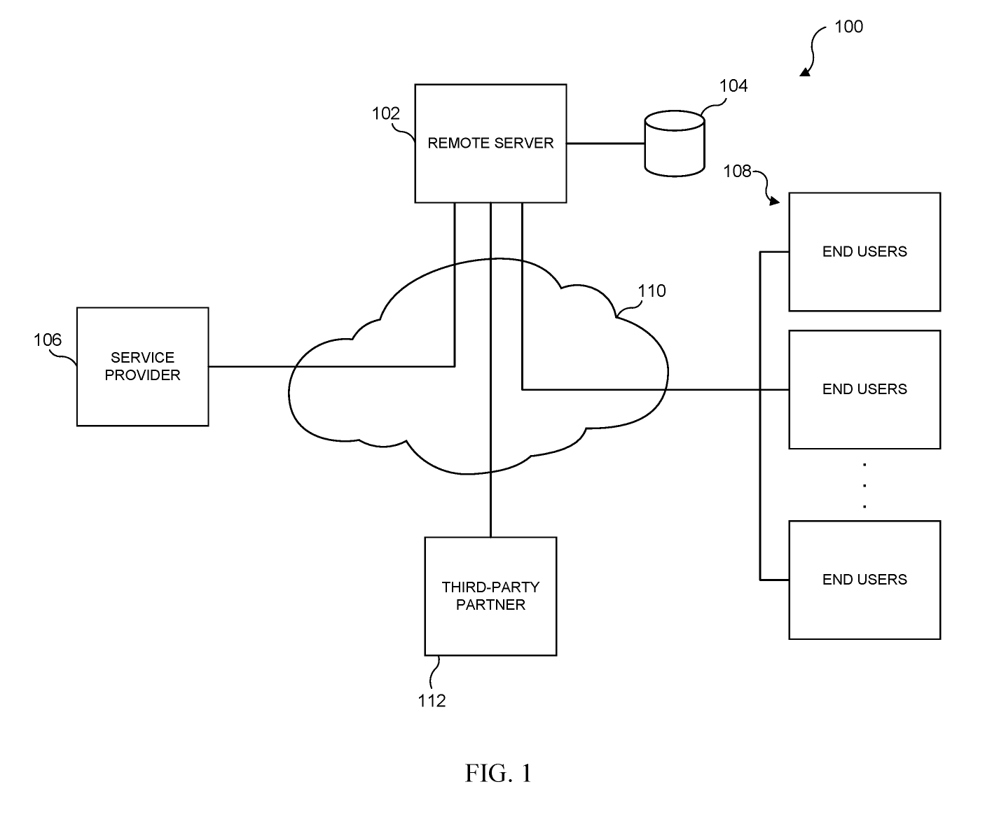

Referring now to FIG. 1, there is illustrated a diagrammatic view of one embodiment of a digital presence system 100. The system 100 includes a remote server 102 having a database 104. The remote server 102 and database 104 are used for storing information for and running a social media platform. The social media platform is provided by a service provider 106 for use by a plurality of end users 108. The social media platform may be branded, such as being called “Highlanders.” The service provider 106 may manage the social media platform running on the remote server remotely over a network 110, i.e., the Internet, or the remote server 102 and the database 104 may also be local to the service provider 106. The plurality of end users 108 connect to the remote server 102 over the network 110 to utilize the social media platform to create accounts, create content such as posts, uploading content such as pictures or videos, and managing their accounts, such as implementing future trigger events, such as those described herein. In some embodiments, a third-party partner 112 partnering with the service provider 106 may also connect to the remote server 102 in order to provide various services to the service provider 106 or to the plurality of end users 108. For instance, the third-party partner 112 may be another social media platform allowing for co-functionality between the third-party partner 112 platform and the service provider 106 platform. The third-party partner 112 may also be a retailer offering to the plurality of end users 108 goods or services for purchase. There may be numerous third-party partners offering a variety of services, goods, or additional functionality.

The social media platform offered by the service provider 106 and run on the remote server 102 allows the plurality of end users 108 to post content to be viewed on a website, on a client application running on a user's device, or via other means. The plurality of end users 108 may also create events to be automatically triggered after a certain trigger condition occurs. This allows for users to maintain a digital presence even after that user is deceased. For instance, after a user is deceased, his or her account may remain active, with certain parameters set for automatically responding to certain events in a variety of ways, as described herein. Users can create an account, connect with other users to form what is known as an “inner circle” with those users, post content on the platform, and save/pin/record posts from themselves or other users, to be used in maintaining a digital presence even after death. Therefore, even after a user is deceased, they can leave a legacy behind, reminding others of their memories by saving posts or content created by the user or other users, offering congratulations or sympathy at important times in family members or friends lives, or buying gifts or providing monetary support for family members, friends, or others. Other social networking systems do not allow for these features. When a user of other social networking platforms dies, the page for that user may still be viewable, and someone set up as an additional administrator of the account may be able to access and edit the page, but no actions associated with that user are able to be performed by the system. In the system disclosed herein, a deceased user's account will still perform actions that the user created while the user was still alive, allowing the user's will to be implemented after death.

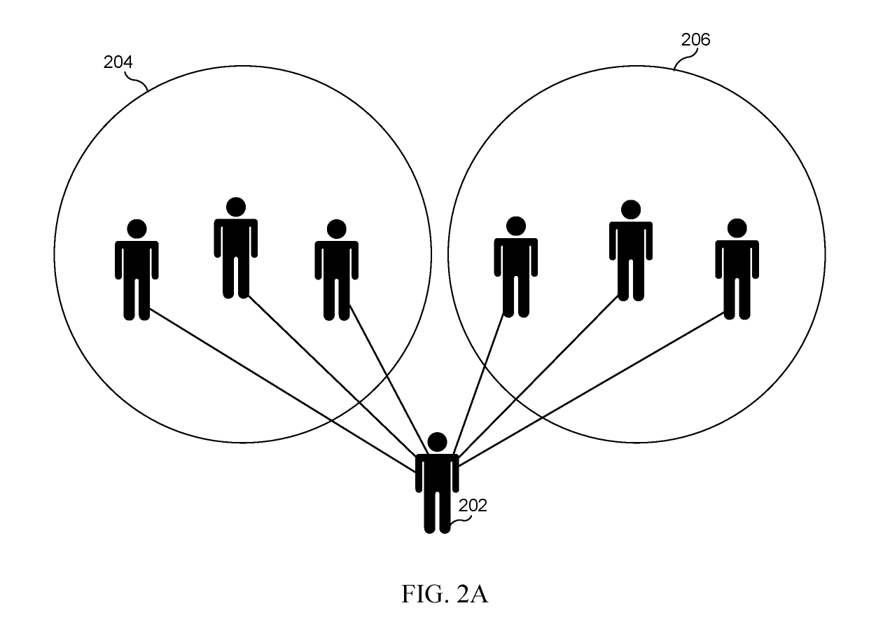

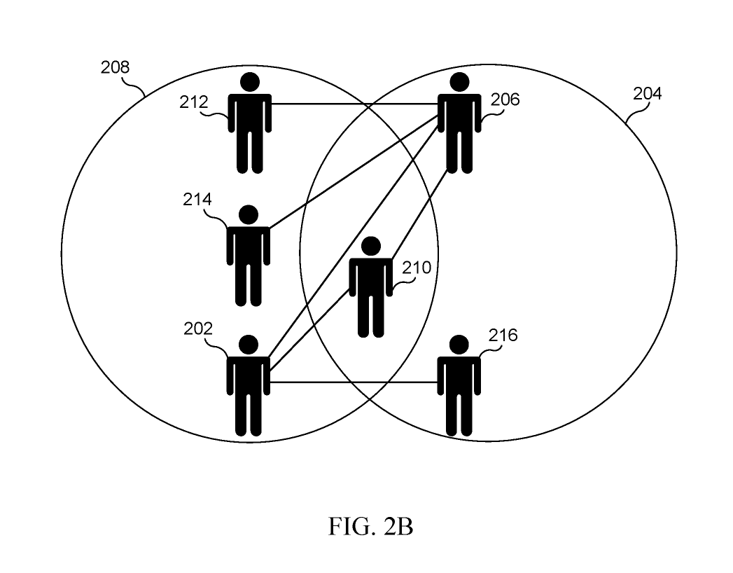

Referring now to FIG. 2A, there is illustrated a diagrammatic view of one embodiment of a user's inner circles. There is shown a user 202 having a plurality of connections with other users. These other users would be designated as friends, mates, connections or other possible labels. User may add these connections by inviting other users to connect, which invitation may be accepted or rejected. The user 202 may categorize these connections into different inner circles. For example, there is shown an inner circle 204. This inner circle may be designated as “family,” with the user 202 placing connections who are familial relatives to the user 202 into this inner circle. A second inner circle 206 is also shown, having a number of connections within. The user 202 may have, for example, labeled this inner circle as “colleagues,” and only places work colleagues within this inner circle. This allows the user 202 to determine when posting content on the social network which users should see the content.

For example, the user 202 may post something regarding his wedding anniversary and choose to only show that post to those in his “family” inner circle and not to his “colleagues” inner circle. The user 202 may additionally choose to only allow certain specific users to see certain posts. In some embodiments, by default there is one main circle containing all of the user connections. A user may create other circles such as family or friends circles and reassign connections from the main circle to one of these other created circles. A user may also have a connection be within multiple circles, such as having a connection be within the main circle, a friends circle, and a colleagues circle. In some embodiments, if a circle is deleted, all connections under that deleted circle that are not assigned to another created circle are moved to the main circle, if they are not already in the main circle.

In some embodiments, connections such as those in the family circle may be tagged with a relationship indicator, such as an indicator for spouse, father, son, etc. Even after a user has passed away, the user's inner circle may grow. For instance, if another user that has not yet been added as the deceased user's connection is marked with at least one family relationship indicator belonging to the deceased user's family, independently from the number of family levels, and that other user sends an invitation to the deceased user, the invitation may be automatically accepted. If another user that is not yet within the deceased user's inner circle is determined by the system to be marked with at least one family relationship belonging to others in the deceased user's family, the other user may receive an automatic invitation to connect from the deceased user. Similarly, in some embodiments, any other user not yet included with a deceased user's inner circle can invite the deceased user to the other user's inner circle. In this case, the invitation may not be accepted, but rather the other user may become a “follower” of the deceased user instead. In such an embodiment, users may be presented with an additional option of setting posts to be public posts, which would allow followers to views the post in addition to their inner circle connections. In other embodiments, the follower function may not be present.

Referring now to FIG. 2B, there is illustrated a diagrammatic view of one embodiment of organizing inner circles for users. Each of the plurality of end users 108 may connect with other ones of the plurality of end users 108, to form social network connections with those chosen users. Each user thus creates his or her own inner circle that includes all of that user's connections. Connections may be known within the system under various names, including friends, connections, mates, or others. There is shown in FIG. 2B a user 202 having an inner circle 204. There is shown another user 206 having an inner circle 208. User 202 and user 206 are connected and thus are within each other's inner circle. Another user 210 is connected with both user 202 and user 206, and thus is within both the inner circle 204 of user 202 and the inner circle 208 of user 206. A user 212 and a user 214 are both connected to user 206, and so both user 212 and user 214 are within the inner circle 208 belonging to user 206. User 212 and user 214 are however not within inner circle 204 belonging to user 202, since user 212 and user 214 are not connected with user 202. Similarly a user 216 is connected to user 202, but not to user 206, causing user 216 to fall within inner circle 204 belonging to user 202, but not within inner circle 208 belonging to user 206.

Inner circles allow for content created or posted by a first user to only appear to users within that first user's inner circle, while that first user is only presented with content created or posted by those within the first user's inner circle. This content may appear in an updating feed containing content from the users in the first user's inner circle, with the feed being shown to the first user upon accessing the social networking platform provided by the service provider 106.

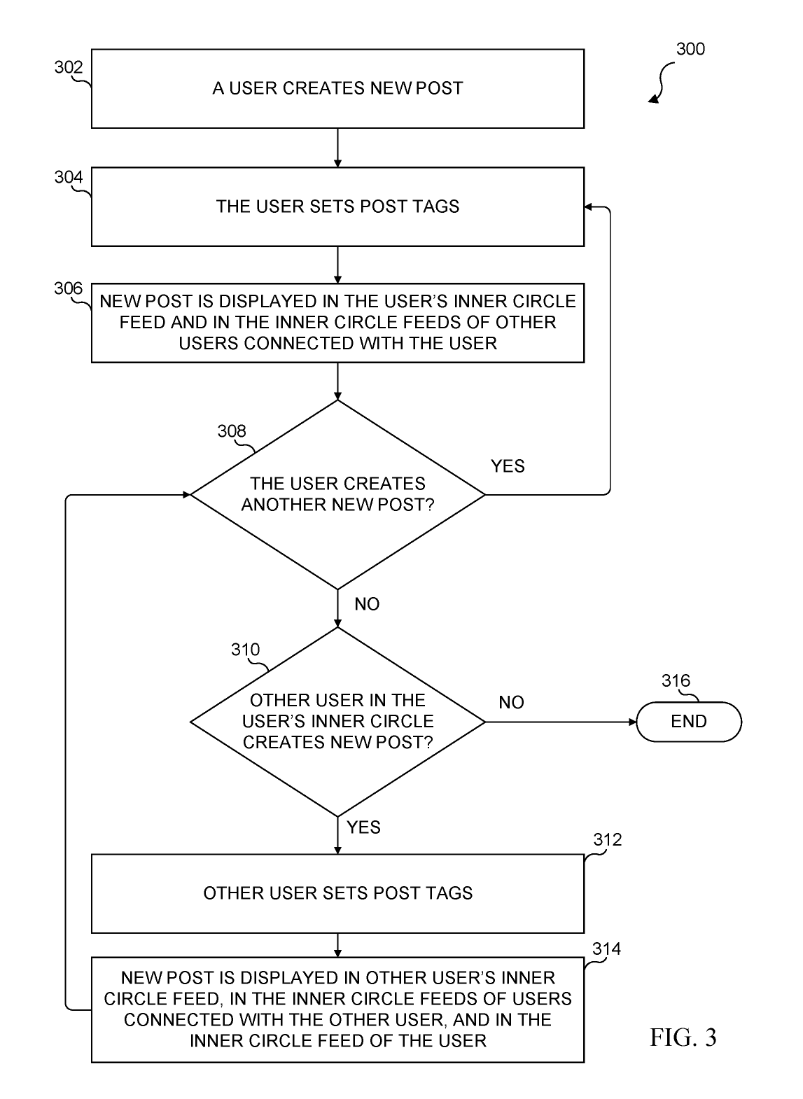

Referring now to FIG. 3, there is illustrated a flowchart of one embodiment of a post creation and inner circle feed update process 300. The process begins at step 302, where a user creates a new post. The new post may be text, a picture, a video, an audio clip, such as voice or music, etc. At step 304, the user sets tags for the post. Tags are used to identify the type of post or the content of the post. For example, a post that serves to upload a video clip of a Red Sox baseball game might be tagged with the words “baseball” or “Red Sox.” At step 306, the new post is displayed in the user's inner circle feed and/or in the inner circle feeds of other users connected with the user who created the post. At decision block 308, the user decides whether to create another new post. If so, the process flows back to step 304. If not, the process flows to decision block 310 where it is determined whether another user in the user's inner circle creates a new post. If not, the process ends at step 316. If so, the process flows to step 312 where the other user sets post tags for his or her created post. At step 314, the other user's new post may be displayed in the other user's inner circle feed, in the inner circle feeds of users connected with the other user, and in the inner circle feed of the first user from step 302. The process then flows back to decision block 308 to repeat the other steps as appropriate.

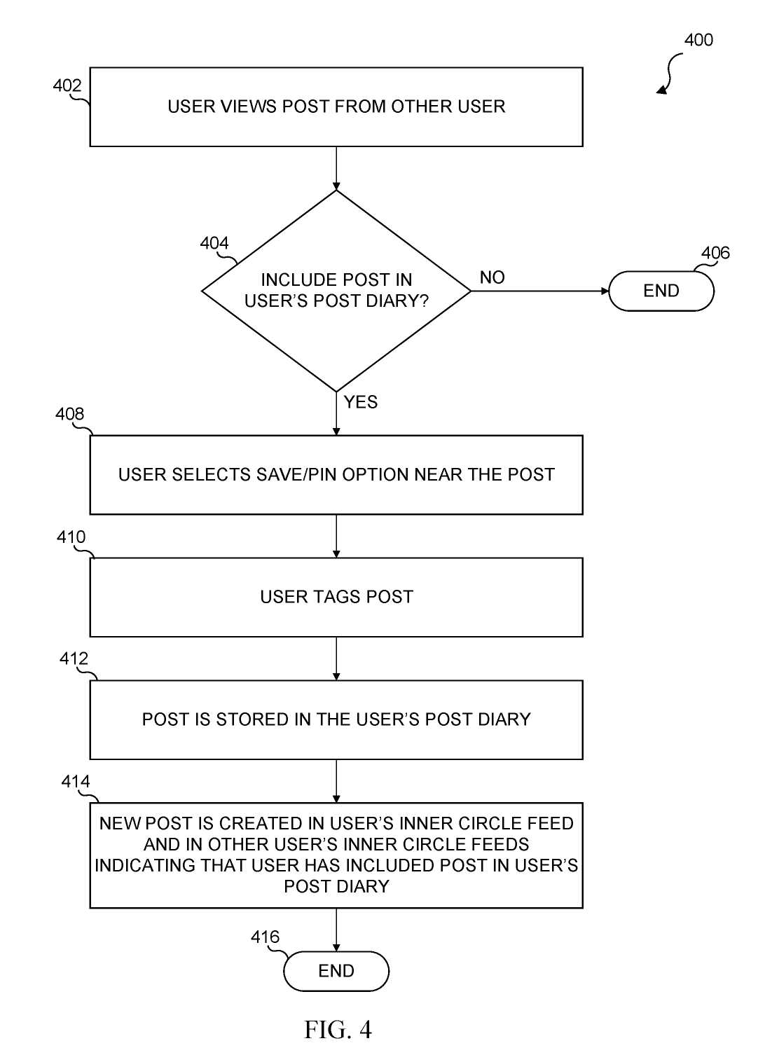

Referring now to FIG. 4, there is illustrated one embodiment of a post saving process 400. The process 400 begins at step 402 where a user views a post from another user. At decision block 404, the user decides whether to save/pin the other user's post in the user's post diary. A user's diary stores saved/pinned posts in one accessible location for the user, allowing the user to save memories to be viewed by the user, or even to be reposted by the user to remind others of these memories, and such reposts may be done even after the user is deceased by setting a future triggered event, as described herein. The saved/pinned posts may also be tagged to provide for the ability to search within or filter the saved posts. If the user decides not to include the post in the user's diary, the process ends at step 406. If the user decides to include the post in the user's diary, the process flows to step 408, where the user selects a save or pin option located near the post being viewed by the user. At step 410, the user may tag the post with his or her own tags separate from any tags assigned by another user who originally created the post. At step 412, the post is stored in the user's diary. In some embodiments, a user may also save or pin the user's own post in the diary. At step 414, a new post may be created in the user's inner circle feed and/or in the inner circle feeds of other users within the user's inner circle, indicating that the user has included the post in the user's diary. The process then flows to end block 416.

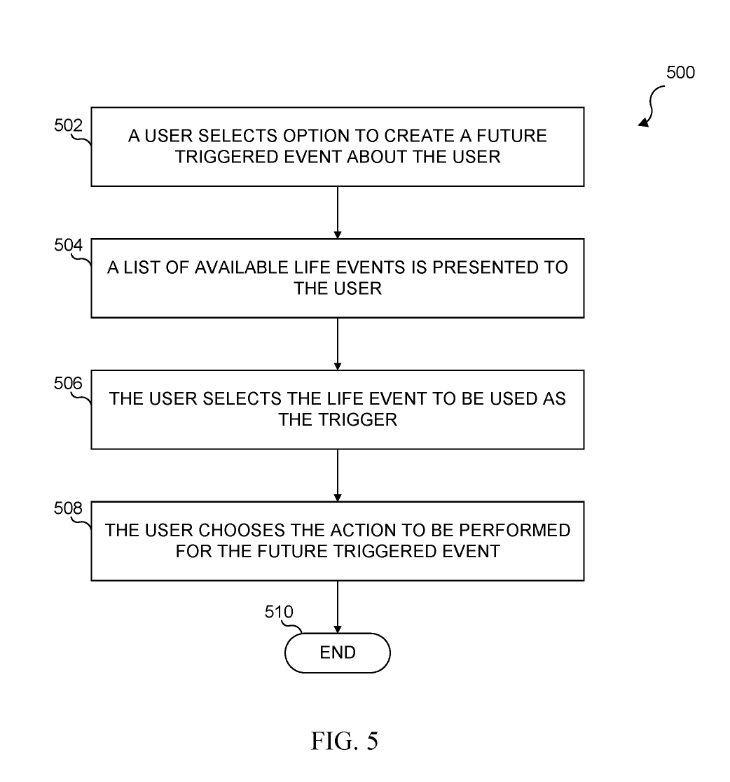

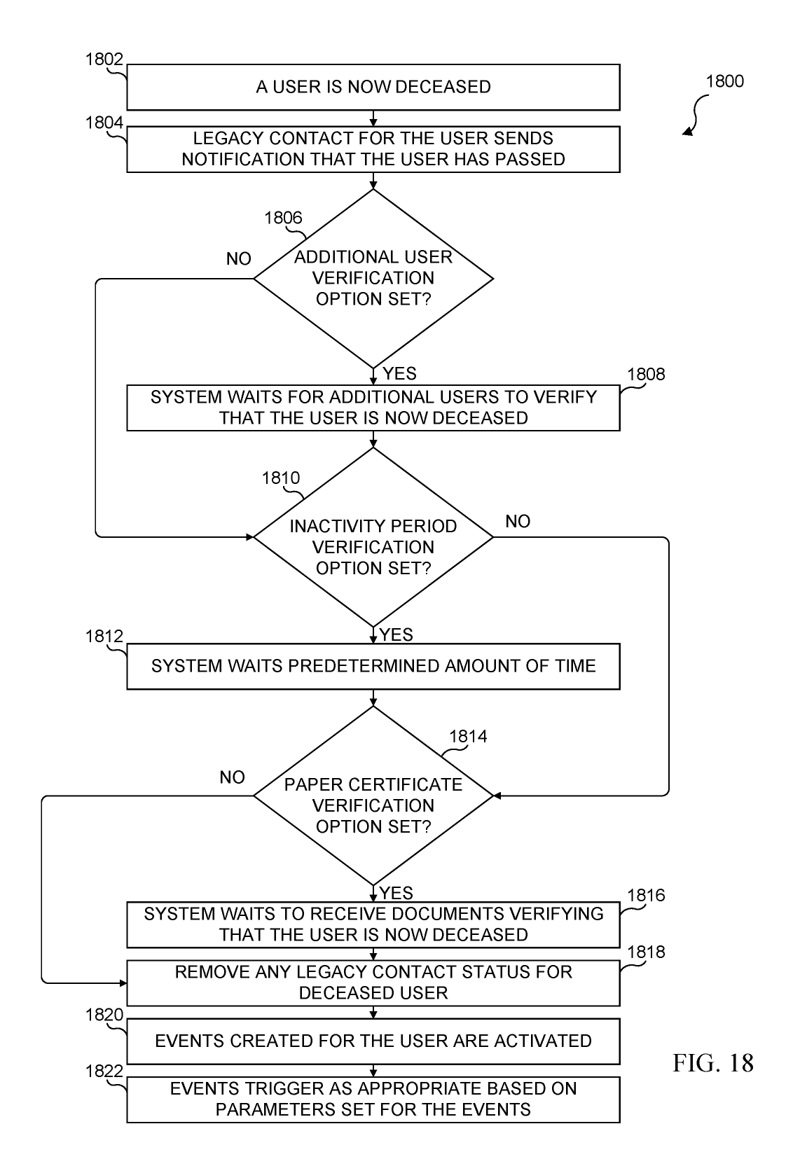

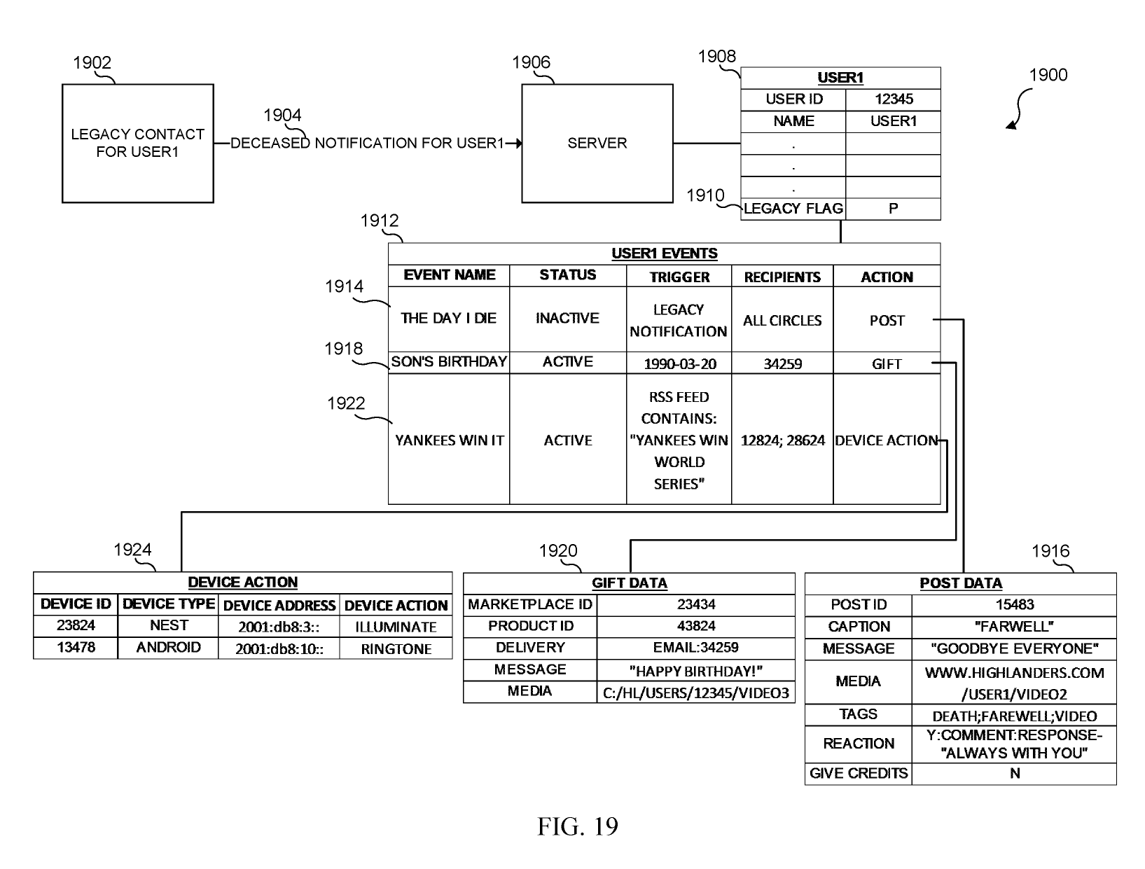

Referring now to FIG. 5, there is illustrated a flowchart of one embodiment of a user life-event-based future triggered event creation process 500. The process 500 begins at step 502 where a user selects an option within the service provider's website or client application to create a future triggered event, where the event is about, or triggered by, a life event of the user. At step 504, a list of available life events is presented to the user. These life events may be the user's birthday, an anniversary of the user, the date of the user's death, a new job, a new relationship or engagement, a new vehicle, a new hobby, etc. In the case of the user's death being chosen, since that date may not be known upon creating the event, the event may be set up, and once the user passes away and a notification of the user's death is received and accepted, such as that described with respect to FIGS. 18 and 19 herein, a date will be set for the date of the user's death, triggering the event and any other events that may rely on this date. At step 506, the user selects the life event to be used as the trigger. At step 508, the user chooses the action to be performed for the future triggered event, as will be described herein. At step 510, the process ends.

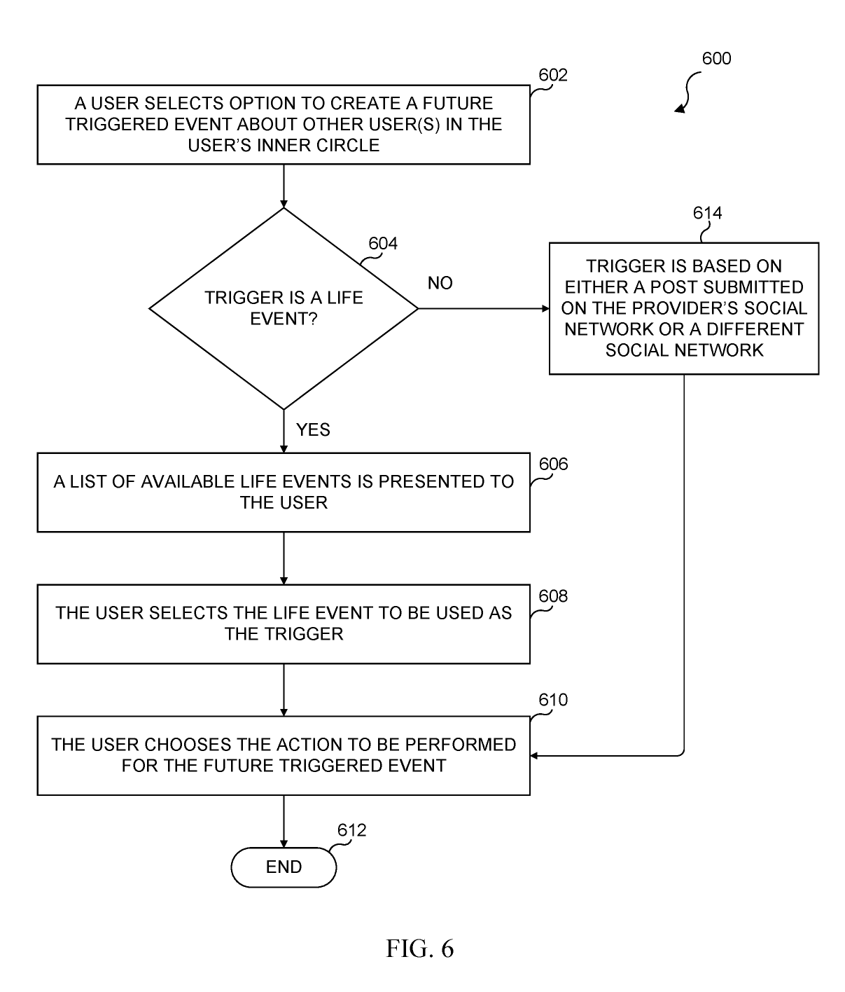

Referring now to FIG. 6, there is illustrated a flowchart of one embodiment of an inner circle user based future triggered event creation process 600. The process 600 begins at step 602, where a user selects an option to create a future triggered event about another user or users in the user's inner circle. The trigger may be applied to any inner circle user, all users in a specific inner circle, or a specific inner circle user. At decision block 604, it is determined whether the trigger is to be about a life event for the inner circle user or users. Such life events may include the birthday of a user, an anniversary, a new job, the death of another inner circle user, or other possible events. This life event may be user specific, or applied to multiple users. For example, the user creating the event may want to send a message automatically to any other user in the user's inner circle when it is that other user's birthday, and may create the event to do so. If at decision block 604, the user chooses to create the event based on a life event of another user, the process flows to step 606. At step 606, a list of available life events is presented to the user. At step 608, the user selects the life event to be used as the trigger for the event. At step 610, the user chooses the action to be performed for the future triggered event. The process then ends at step 612.

If, however, at decision block 604 the user chooses to not create the event based on a life event of another user, the process flows to step 614. At step 614, the user can select an option to have the event triggered by a post submitted by another user, either on the service provider's social network, or on some other social network, such as Facebook or Twitter. This option allows for a triggered action to be performed in response to another user posting something online. For example, if another user in the user's inner circle posts a text post on the service provider's social network, the user's account may automatically respond by posting a message, a reaction, or some other action, with the action being any of the available actions that can be chosen by the user, as described herein. The same will happen process will occur if the other user posts something on another social network. For example, if the other user posts a video on Facebook, the account for the user who created the event may respond by posting a reaction, buying a product or service for the other user, or other available actions described herein. The process then flows to step 610 where the user chooses the action to be performed din response to the trigger.

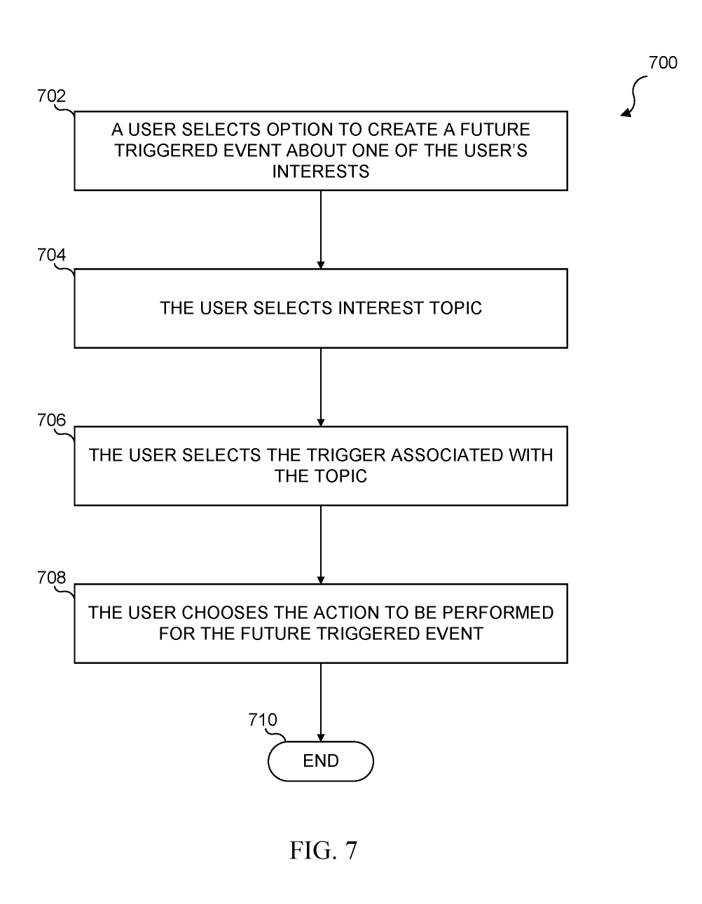

Referring now to FIG. 7, there is illustrated a flowchart of one embodiment of a user interest based future triggered event creation process 700. The process 700 begins at step 702 where a user selects an option to create a future triggered event about one of the user's interests. These interests may include sports, news, celebrities, technology, food, or other interests. At step 704 the user selects an interest topic. At step 706, the user selects the trigger associated with the topic. This trigger may be a post on a social network, such as a post from another user on the service provider's social network, or on another social network such as Facebook. The trigger selected at step 706 may be set up to detect posts that match a particular interest. For example, the trigger may be set to respond to posts in the user's inner circle regarding ESPN. The trigger may also be activated in response to a new post that contains an interest. For example, if the user's interest is golf, the trigger may activate when another user submits a post containing something regarding golf, such as mentioning the game of golf itself, posting a video of a professional golfer, or posting a link to a new article regarding the U.S. Open. Specific phrases within posts, or derivatives of a phrase, may also be used as the trigger. For example, the phrase “New Italian Restaurant Opens in Manhattan” may be set as the trigger. In the event that the exact phrase is not used in a post, the derivatives of the phrase may be searched for, such as searching for whether the words “Manhattan,” “Italian,” and “New Restaurant” appear near each other, such as in the same sentence, in the post. Triggers may also be set up for detecting and triggering an event when a text, picture, video, or other media is posted. In some embodiments, the trigger may look for a specific interest within the media, such as determining by image recognition that a particular object or person appears in the media. The user may also link sources to be used to detect interests, such as a feed for a band's Twitter page, allowing for their Twitter posts to be used as a trigger for the event, such as triggering whenever the band posts a Tweet, or triggering when the band mentions something specific in a Tweet, such as if the band Tweets that they will soon be playing in the user's hometown. The process moves to step 708 where the user chooses the action to be performed in response to the trigger, as described herein. The process then ends at step 710.

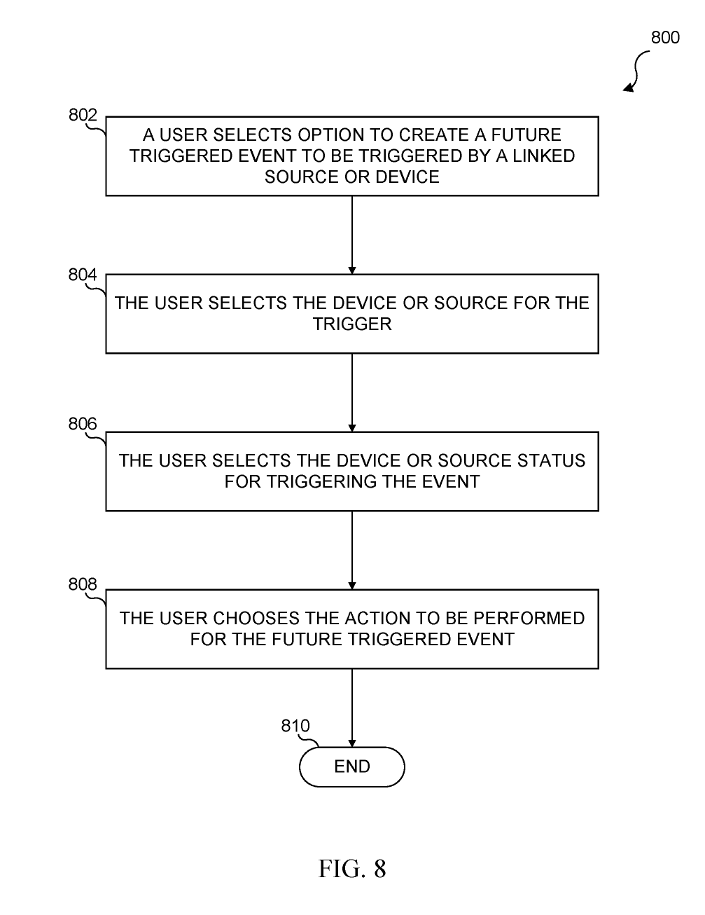

Referring now to FIG. 8, there is illustrated a flowchart of one embodiment of a linked device based future triggered event creation process 800. The process begins at step 802 where a user selects an option to create a future triggered event to be triggered by a linked device or a linked source. Such a linked source or device may be any device connected over a network and capable of communicating with the remote server 102. For example, a smart thermostat such as the Nest thermostat may be linked and set as the triggering device. In this example, the user may set the trigger to activate when the temperature in his brother's house, as read by the smart thermostat, goes below 50 degrees Fahrenheit. The trigger may cause a message to be posted to the user's brother on a social network, such as “it's cold in your house!” The trigger may also manipulate the Nest thermostat to turn on the heater in the house in addition to creating the post. The trigger may also be used to support a cause or charity. For example, if the thermostat mentioned goes below a certain temperature, the event triggers and the user who created the event donates accumulated credits or money to a particular charity that provides shelter or supplies to the homeless, and creating a post inviting other users to do the same. At step 804, the user selects the device or source to be used as the trigger. At step 806, the user then chooses the parameters for the trigger, such as a certain status or event detected by the source or device. At step 808, the user chooses the action to be performed for the future event when the trigger event takes place, as described herein. The process then ends at step 810.

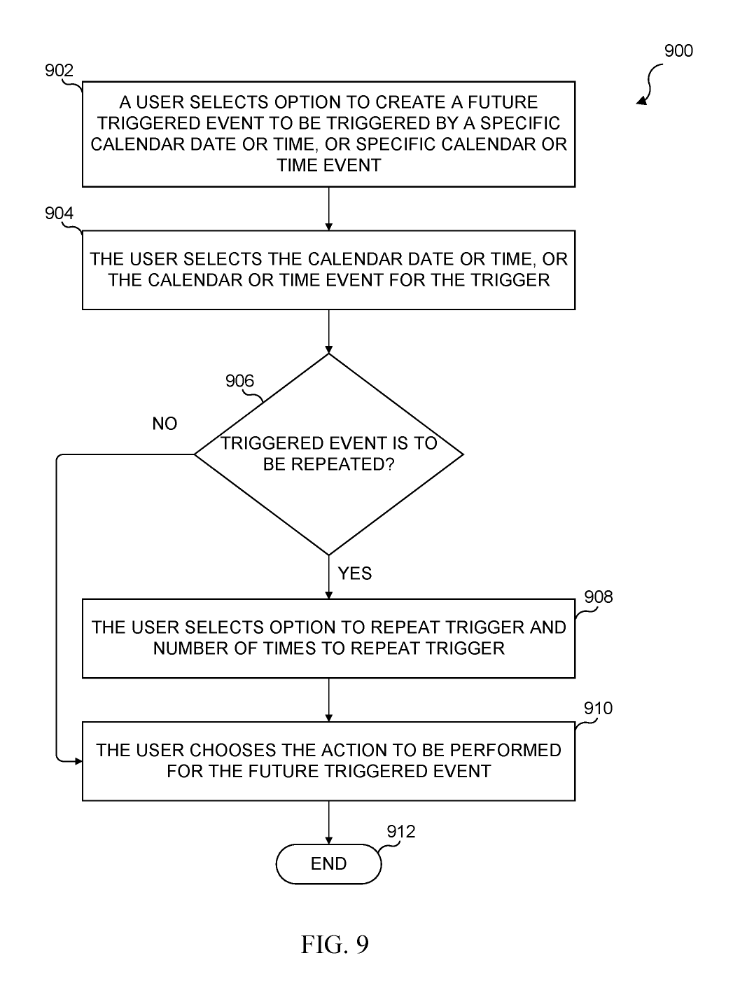

Referring now to FIG. 9, there is illustrated a flowchart of one embodiment of a calendar or time based future triggered event creation process 900. The process 900 begins at step 902 where a user selects an option to create a future triggered event to be triggered by a specific calendar date or time, or a specific calendar or time event. For example, the user may select a specific date or time, or a combination, as the trigger. For example, the user may set the trigger to be every first day of every month. The user may further define that the trigger occurs on every first day of every month, at 2:00 PM. The user may also set a specific calendar event, such as setting the trigger to occur on Thanksgiving. The user may select a specific Thanksgiving, such as Thanksgiving 2018, set the trigger to repeat every Thanksgiving of every year, or even to repeat on only certain years, such as every even-numbered year. At step 904, the user selects the calendar date or time, or the calendar or time event to be the trigger. At decision block 906, it is determined whether the event should be a repeated event. If so, the user selects, or sets the parameters for, the repeated trigger, and the number of times to repeat the trigger. At step 910, the user chooses the action to be performed for the future triggered event, as described herein. The process then ends at step 912. If at decision block 906 it is determined that the trigger event should not be repeated, the process skips step 908 and moves to step 910.

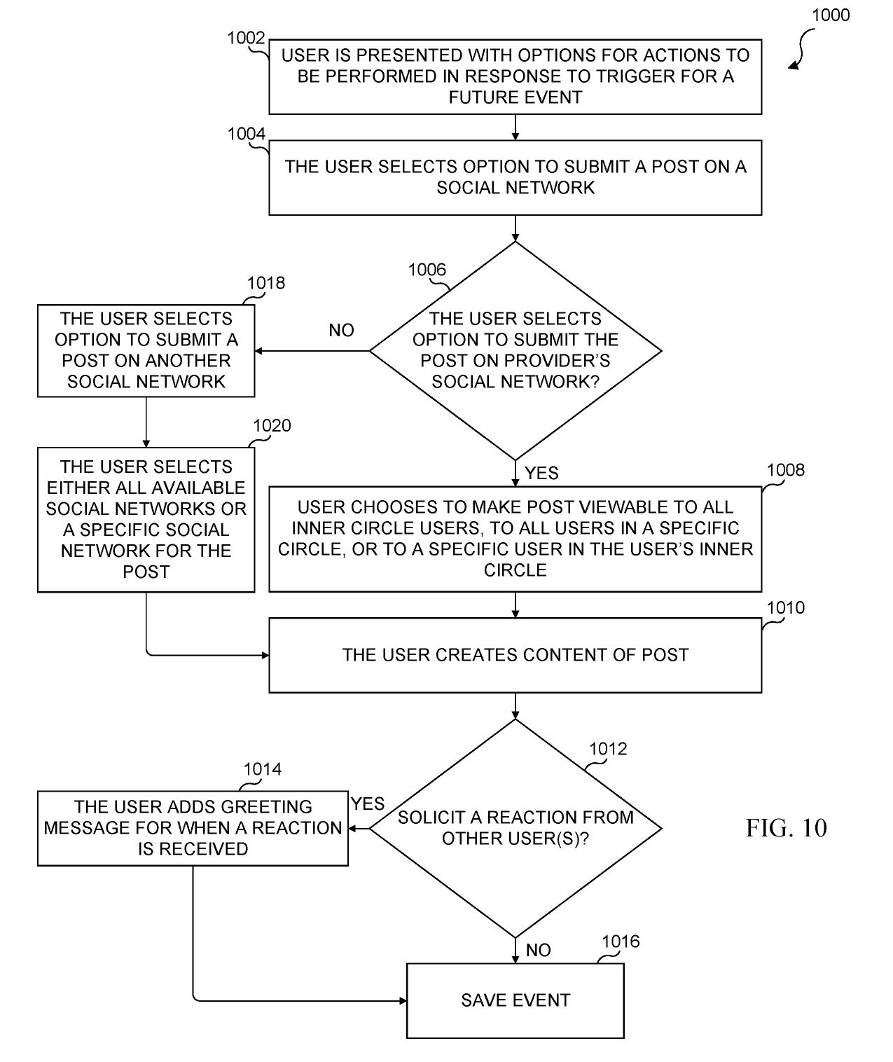

Referring now to FIG. 10, there is illustrated a flowchart of one embodiment of a triggered post creation process 1000. The process 1000 begins at step 1002 where a user is presented with options for actions to be performed in response to a previously-set trigger for a future event. The previously-set trigger may be any defined-trigger, such as those described with respect to FIGS. 3-9. At step 1004, the user selects an option to submit a post on a social network in response to the trigger. At decision block 1006, it is determined whether the post is to be submitted on the service provider's social network. If so, at step 1008, the user chooses a recipient(s), including whether to make the post viewable to all inner circle users, to all users in a specific inner circle, or to a specific user in the user's inner circle. At step 1010, the user creates the content of the post, such as entering text, uploading audio, a picture, or a video, or other content. The user, instead of having to create the content during event creation, may also select content from items already saved in the user's diary, such as selecting a saved post in the user's diary in order to post contents of that saved post when the event triggers. At decision block 1012, it is determined whether the user wishes to solicit a reaction from other users. Such a solicitation would invite other users to react to the post created by the triggered event, with such reaction solicitations being, for example, an invite to “love” the post, an invite to comment on the post, or an invite to make a gift or donation in response to the post, such as if the post is about a charity and any gifts or donations would be made to the charity. Gifts may also be made to other users. For example, if the triggered post is triggered because it is the user's son's birthday, other users may be invited to make a gift to the user's son.

If the user decides to solicit reactions at decision block 1012, the process flows to step 1014 where the user can add a greeting message that is sent to another user if that other user reacts to the triggered post. This greeting message may also provide to the user or users who reacted to the triggered post a reward for reacting, such as giving a gift or giving away credits accumulated by the user who created the triggered event. Credits (or Hredits (Highlander Credits)) may be accumulated by users for generating ad traffic with their posts, and even triggered posts, due to ad space provided on the website or client application. Credits can even be collected after death. In addition to traffic rewards, credits may be purchased with money or through gifts or solicitations for credits. Credits may also be generated for users through the steps necessary to create content for the social networking platform. Credits may also be passed from one user to another when a user reacts to a user's posted content, such as when a user “loves” another user's post. Credits may also pass from one user to another when a request to connect with a user is granted, passing credits from inviter to invitee. Once a user accumulates credits, these credits may then be given to other users, or used to buy products and services from the third-party partners 112. These products and services may be then given as gifts to other users. For instance, if a triggering event is based on a user's wedding anniversary date, he may have set the event to send a message to his wife, and for the event to buy flowers from a third-party partner 112 and have them delivered to his wife. This may even be set to occur after the death of the user, so that each year after his death his widow would still receive a gift from him. Credits may also be given to causes and charities, either set up by a user or given directly to a charity if that charity becomes a third-party partner 112. In some embodiments, users may not be able to spend their credits on others until they pass away. Other types of users such as charitable organizations or third-party partners 112 may also accumulate credits, such as by receiving credits from users to support a charity or when purchasing items.

The process then flows to step 1016 where the user saves the event, to be triggered upon the occurrence of the set trigger or triggers. If at decision block 1006, the user does not wish to submit the post on the service provider's network, the user can instead submit the post on another social network integrated or connected with the service provider's network. If that is the case, at step 1018, the user selects the option to submit the post on another social network. At step 1020, the user may select all available social networks or a specific social network for the post. The process then flows to step 1010 and follows accordingly with the process 1000 described herein. The social networking platform described herein can connect to other social networks, websites, or other sources. For example, a user may link to that user's Facebook, Twitter, Snapchat, Instagram, or other social media sources. A user may also link to email accounts, cloud storage such as Dropbox or Google Drive, other websites, such as news sites using RSS or APIs, or even other devices such as a user's phone, PC, tablet, or IoT (Internet of Things) devices such as sensors, thermostats, accelerometers, or other IoT devices.

A directory of compatible RSS and blog feeds may be kept updated and available on the server, allowing for users to use those feeds in posts and for triggering future events. Feeds and channels external to the service provider's social networking platform, even including connected IoT devices, are sources of possible content to be added to the platform, are sources for possible events to be triggered for future events, and are used for directions for possible action to be performed when a specific event is triggered. In some embodiments, feeds and other channels may be linked to a user's profile in order to be exploited as “interests” or as “linked accounts.” The platform may create “interest pages out of a select set of sources coming from multiple kinds of originators, such as newspapers, magazines, companies, associations, public figures, places, events, shopping sources, sports teams, etc. Each select source may be normalized in a preformatted way, such as an HTML page, using the RSS/web content and may also be assigned a specific identifier (ID) for use with the platform.

In some embodiments, when a user reacts to a page containing feed or channel content, such as “loving” a page, the system may tag the page among the user's interests. From that moment on, new posts for that source may also appear in the user's “My Inner Circle” feed. Pages containing feed or channel content may also be pinned and shared by users. Interest pages may also have users as editors, allowing users to edit and add new content on the page once it is claimed by the owner.

In some embodiments, only “pre-vetted” sources will be available on the platform. In some embodiments, users may be representatives of these pre-vetted sources, and may claim the pre-vetted sources to add updates to the sources. For example, if a New York Times source is pre-vetted and included in the system, and a user is an editor for the New York Times, that user may request rights to access and edit the New York Times source/feed on the platform. Such a request may require a phone call with the user and other verification processes to ensure that the user is in fact a representative of the source. Pre-vetting of sources and verification of users of those sources increases the trustworthiness of sources. For example, instead of allowing for fake news sources to be shared and posted by users, giving posts an air of credibility even though the news is fake, sources would have to be pre-vetted and content shared from those sources would be curated to only include legitimate content updates from those pre-vetted sources.

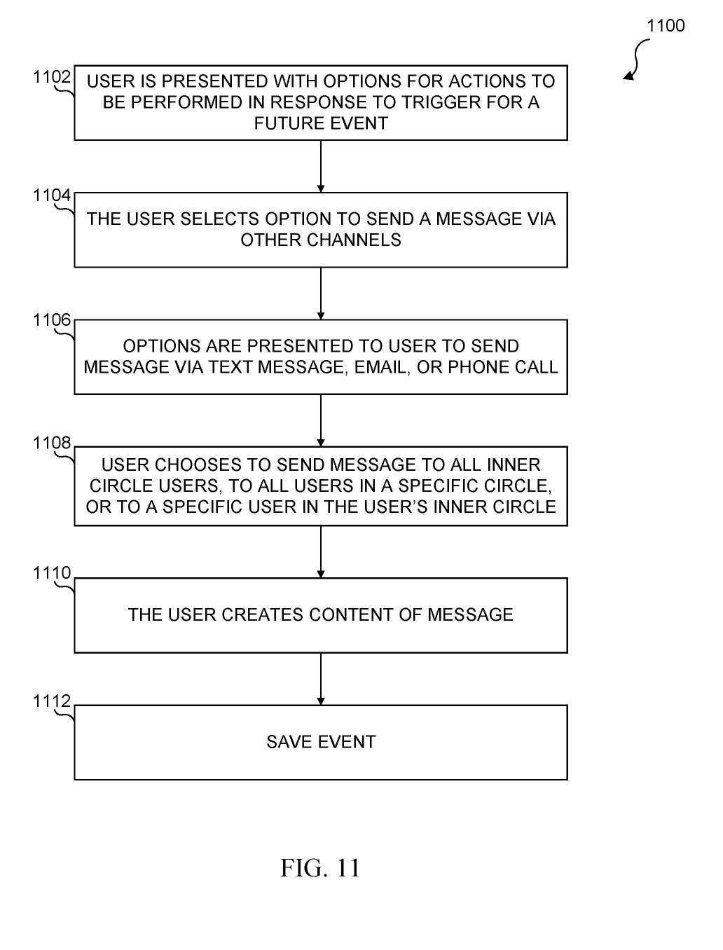

Referring now to FIG. 11, there is illustrated a flowchart of one embodiment of a triggered message transmission process 1100. The process 1100 begins at step 1102 where a user is presented with options for actions to be performed in response to a previously-set trigger for a future event. At step 1104, the user selects an option to send a message to another user via other channels, i.e., not via the social network or other social networks. At step 1106, options are presented to the user for sending a message via a phone call, an email, a text, or other means. At step 1108, the user may choose to send the message to all inner circle users, to all users in a specific inner circle, or to a specific user in one of the user's inner circles. At step 1110, the user creates the content of the message. If the message is to be sent via phone call, the user may provide a pre-recorded message to be delivered. If an email or text is to be sent, the user may provide text input for the email or text, as well as audio, video, pictures, or other content. The user, instead of having to create the content of the message during event creation, may also select message content from items already saved in the user's diary, such as selecting a saved post in order to send the contents of that saved post to another user via text, email, a phone call, or other means when the event triggers. At step 1112, the user saves the future event.

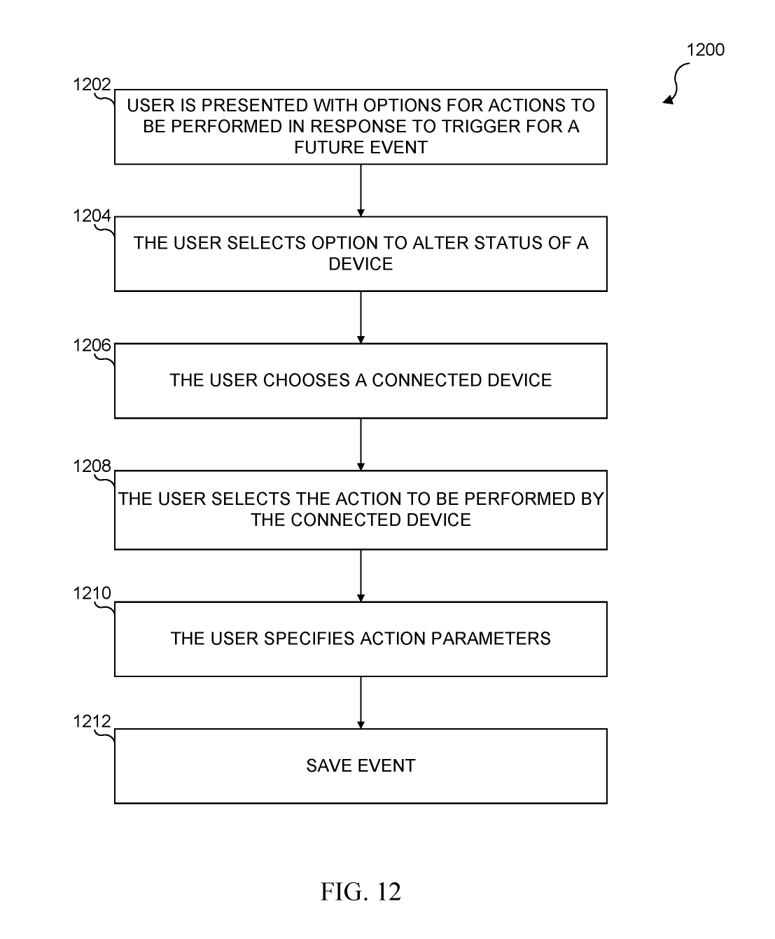

Referring now to FIG. 12, there is illustrated a flowchart of one embodiment of a triggered device status alteration process 1200. The process 1200 begins at step 1202 where a user is presented with options for actions to be performed in response to a previously-set trigger for a future event. At step 1204, the user selects an option to alter the status of a linked device. This status alteration may be any change made to the device. For example, if the trigger for the future event occurs when another's user's smart thermostat in that user's house goes below 50 degrees Fahrenheit, the event may be triggered, causing the thermostat to be set to 70 degrees Fahrenheit to activate the heater to warm the user's house. As another example, if the trigger for the event is that the Red Sox have won the World Series, another user's phone may be activated to start playing music. At step 1206, the user chooses a linked or connected device that will be altered if the event is triggered. At step 1208, the user selects the action to be performed by the linked or connected device. At step 1210, the user specifies the action parameters. At step 1212, the user saves the event.

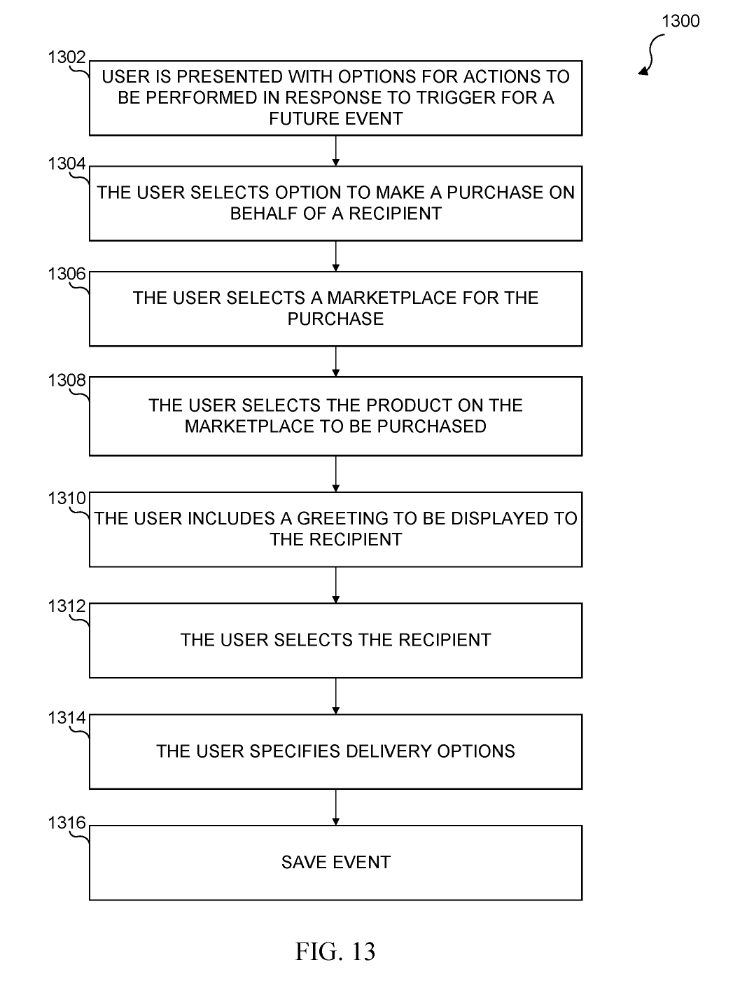

Referring now to FIG. 13, there is illustrated a flowchart of one embodiment of a triggered purchasing process 1300. The process 1300 begins at step 1302 where a user is presented with options for actions to be performed in response to a previously-set trigger for a future event. At step 1304 the user selects an option to make a purchase on behalf of a recipient. At step 1306, the user selects a marketplace for the purchase. A marketplace may be a store front for a third-party partner 112, or similar section of the web site or client application. At step 1308, the user selects a product or service on the marketplace to be purchased. At step 1310, the user may include a greeting to be displayed to the recipient when the purchase is delivered to the recipient. At step 1312, the user selects the recipient who is to receive the purchase. The recipient may be a user in one of the user's inner circles or an interest organization such as a charitable organization, a sports team, a newspaper, or other entity, in order to provide support for a cause or initiative. At step 1314, the user specifies delivery options for the purchase. If the purchase is for a digital product, such as a digital audio track or a movie, the purchase may be delivered within a post delivered on the social network or another social network, may be emailed, or may be delivered to the recipient in some other way. If the purchase is for a physical product or service, the user may select shipping options or may schedule a time for the services to be rendered. At step 1316, the event is saved.

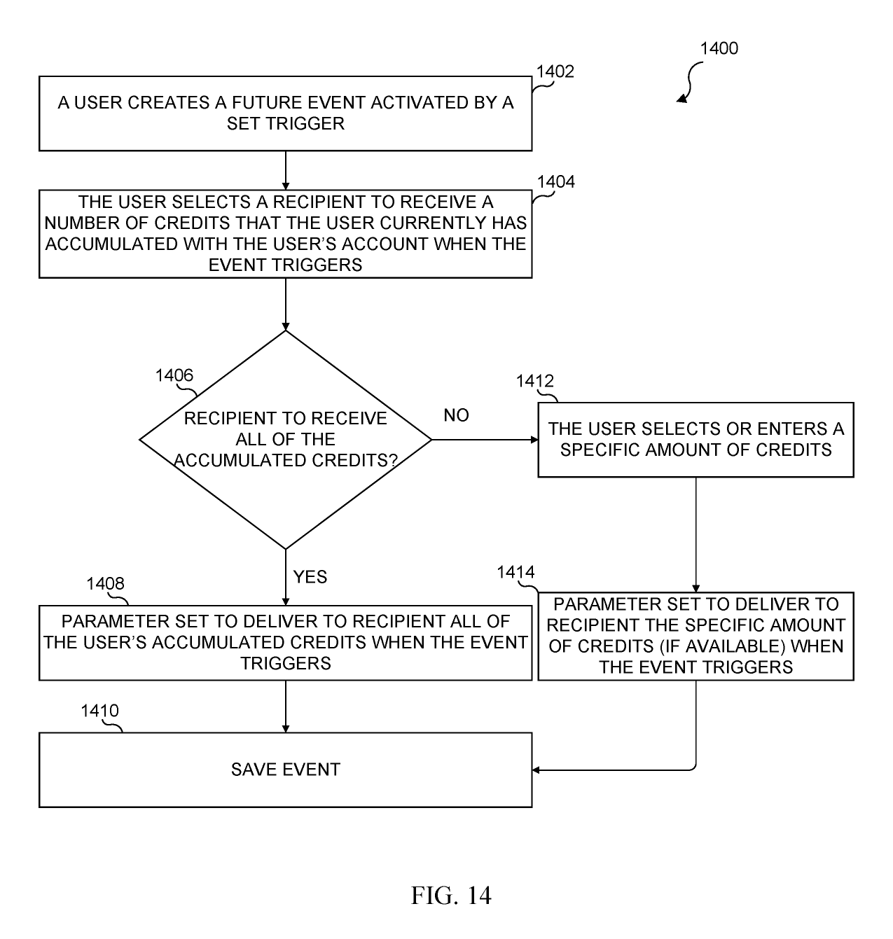

Referring now to FIG. 14, there is illustrated a flowchart of one embodiment of a credits gifting process 1400. The process 1400 begins at step 1402 where a user creates a future event activated by a set trigger. At step 1404, the user selects a recipient to receive a number of credits that the user currently has accumulated with the user's account when the event triggers. The recipient may be a user in one of the user's inner circles or an interest organization such as a charitable organization, a sports team, a newspaper, or other entity, in order to provide support for a cause or initiative. At decision block 1406, it is determined whether the recipient is to receive all of the accumulated credits. If so, at step 1408, a parameter is set to deliver to the recipient all of the user's currently (at the time the event is triggered) accumulated credits (if any) when the event triggers. The event is then saved at step 1410. If at decision block 1406, it is instead determined that the recipient is not to receive all accumulated credits, the process moves to step 1412 where the user selects or enters a specific amount of credits. At step 1414, a parameter is set to deliver to the recipient the specific amount of credits (if available) when the event triggers. If the specific amount is not available when the event triggers, a smaller amount or the total currently accumulated may be given. In other embodiments, if the specific amount is not available when the event triggers, no amount is given and the event may not trigger at all. After step 1414, the process then moves to step 1410 to save the event.

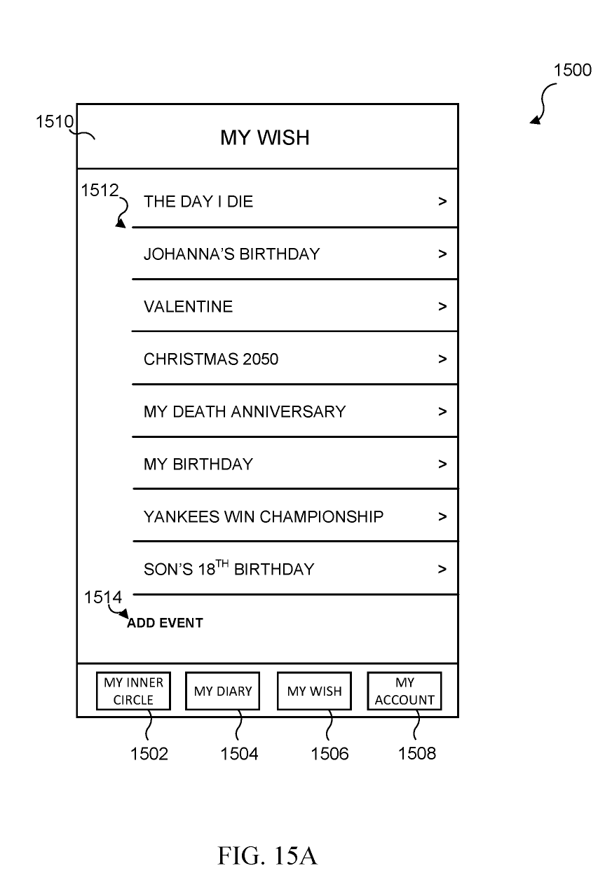

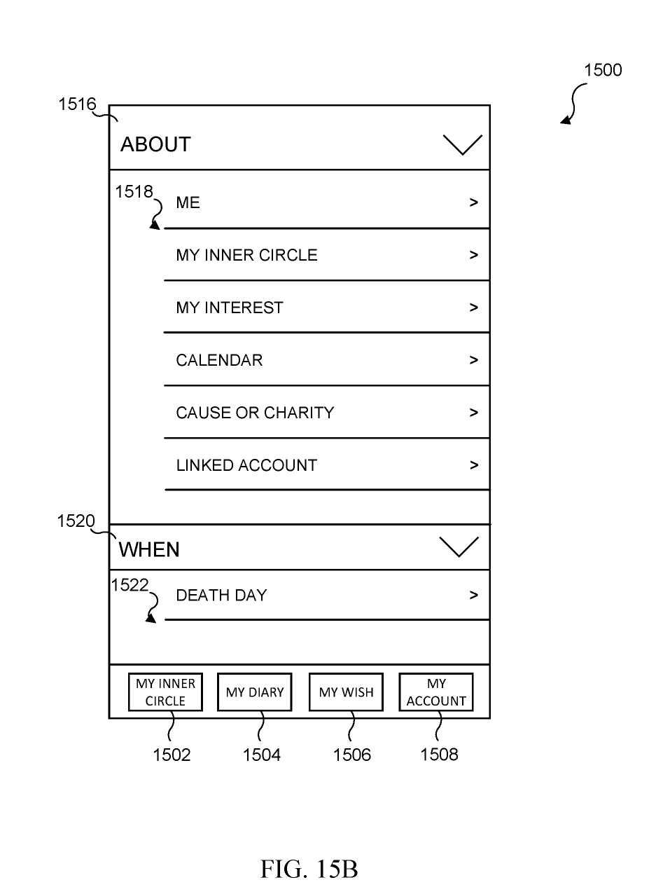

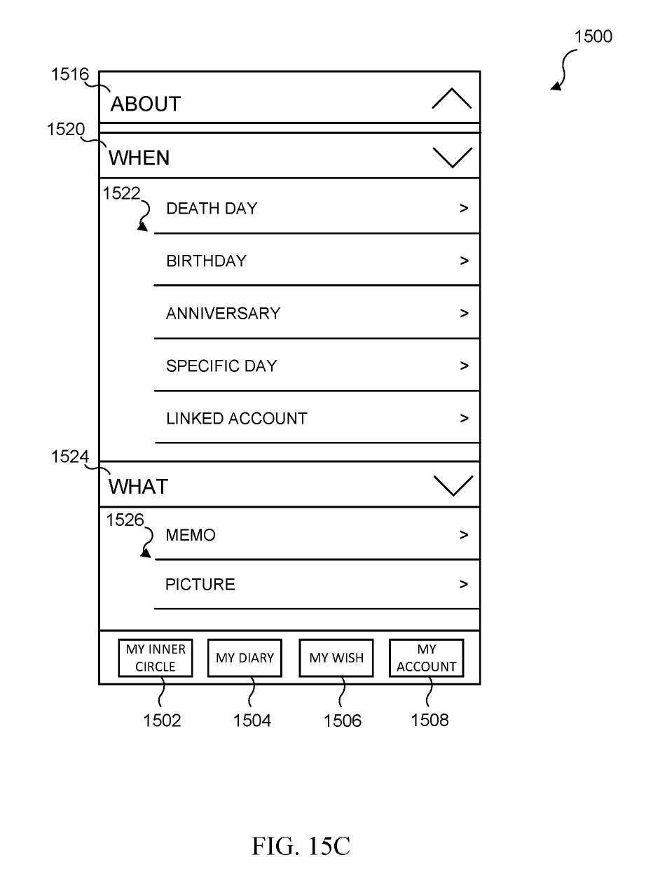

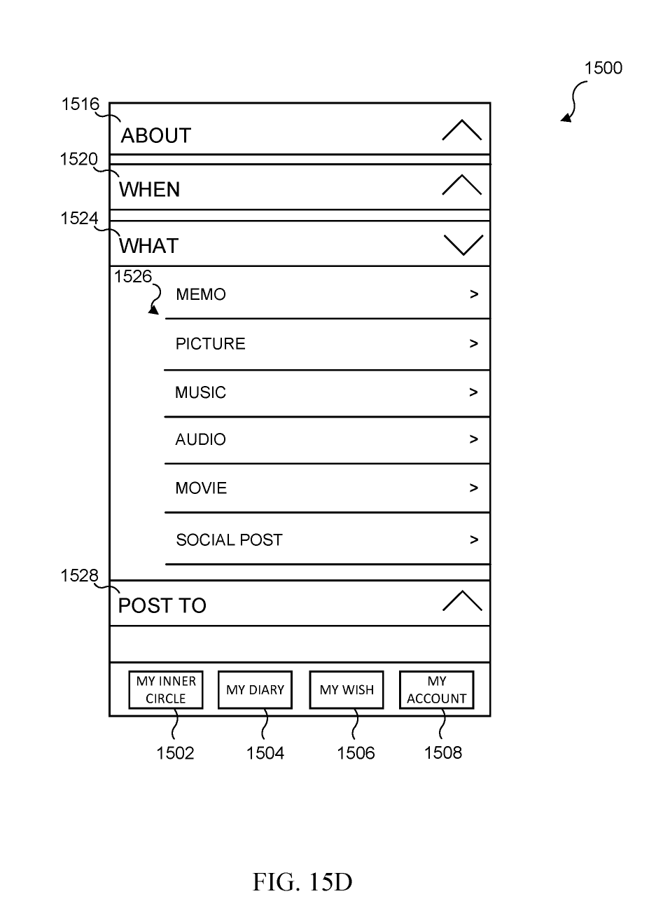

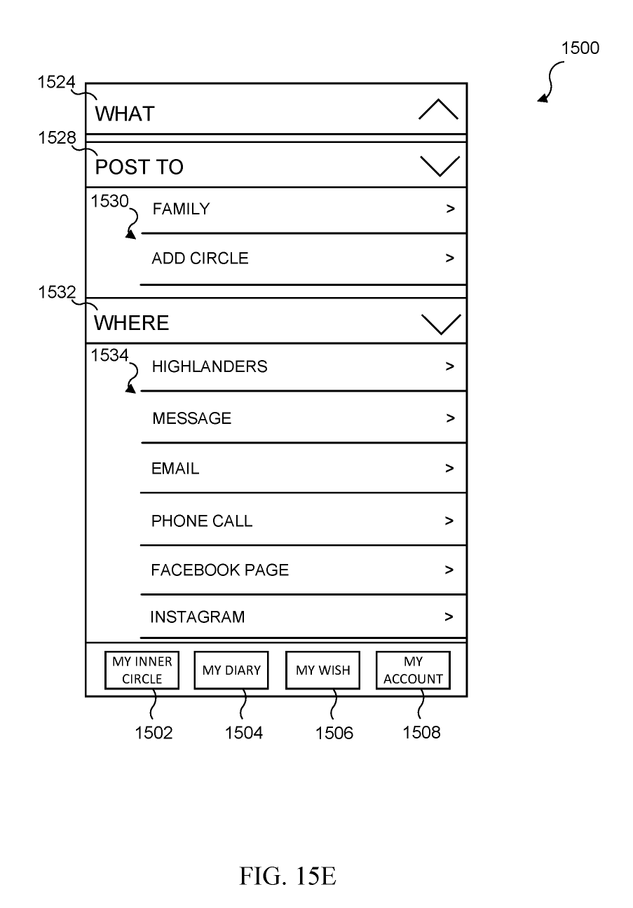

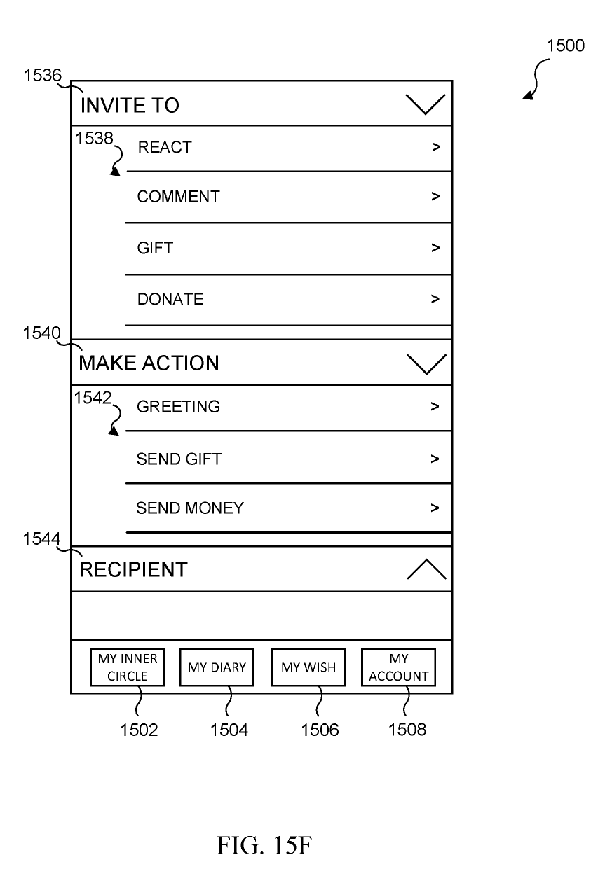

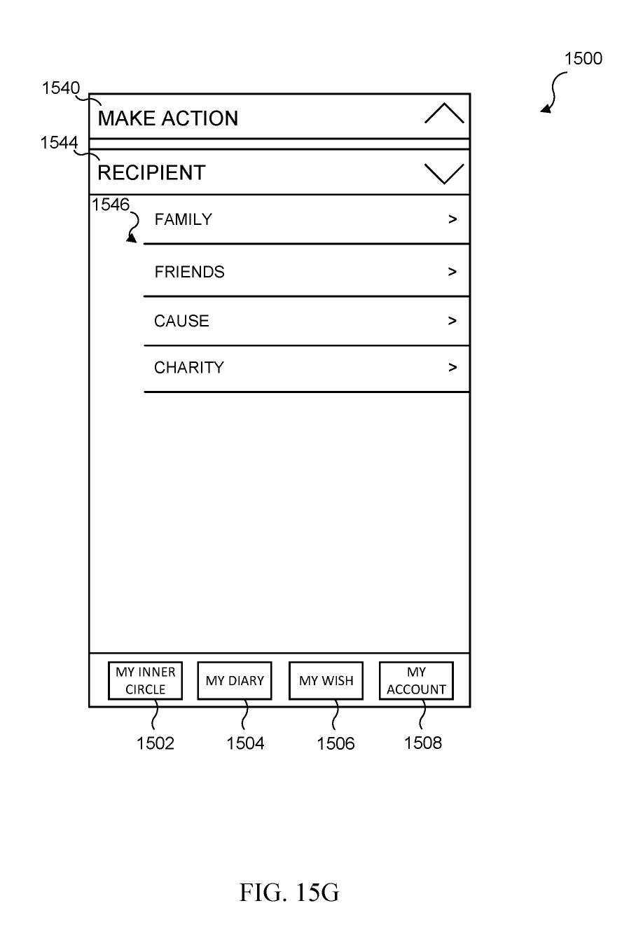

Referring now to FIG. 15A, there is illustrated one embodiment of a future event creation graphical user interface (GUI) 1500. The GUI 1500 may have a “My Inner Circle” button 1502, a “My Diary” button 1504, a “My Wish” button 1506, and a “My Account” button 1508. In some embodiments, there may be instead a dropdown menu that allows a user to select from the options “My Inner Circle,” “My Diary,” “My Wish,” and “My Account,” instead of providing a button for each option. The “My Inner Circle” button 1502 allows a user to view the user's inner circles and the people within those inner circles, as well as viewing a main “My Inner Circle” feed that updates to show content posted by the user's connections, in addition to the user's own posts. The “My Diary” button 1504 allows the user to view saved or pinned posts that are stored in the user's diary. The “My Account” button 1508 allows the user to view details regarding the user's account and manage the account, such as changing login information, contact information, or other information. The “My Wish” button 1506 allows a user to view and create future events for the user's account. FIG. 15A shows an initial page that may presented when the “My Wish” button 1506 is selected. This page has a title section 1510 with the title “MY WISH” listed. Below the title section 1510 is a plurality of future events 1512. If no events have been created by the user, this list may be blank. However, as shown in FIG. 5A, multiple events may be created and stored. Such events may include birthdays, holidays such as Christmas, sports events, the day the user dies, or the anniversary of the user's death. Below the plurality of future events 1512 is an “Add Event” option 1514 that, when selected, allows a user to create a new future event. The listed events may also be deleted by entering certain inputs, such as a swipe gesture if on a touchscreen device, or a right-click on a mouse if on a PC device.

Referring now to FIG. 15B, there is illustrated another view of the GUI 1500. This view is a page that is shown after the “Add Event” option 1514 is selected by a user, and may also be shown when a user selects a previously created event from the plurality of future events 1512 in order to edit that previously created event. There is shown an expandable “About” list 1516 having a plurality of options 1518 for choosing what the event trigger is concerning. An expandable “When” list 1520 is presented below the “About” list 1516. The “When” list 1520 has a plurality of options 1522 for setting when a trigger is to occur. This may include a specific day, such as a holiday or birthday, or in response to a linked account, such as an RSS feed for a sports team. It will be understood that the page can be scrolled through to reach different expandable lists, as will be shown in other figures herein.

Referring now to FIG. 15C, there is illustrated another view of the GUI 1500. This view is the page of FIG. 15B, but scrolled down and the “About” list 1516 collapsed. There is further shown an expandable “What” list 1524 having a plurality of options 1526 for selecting a post type to submit in response to the trigger.

Referring now to FIG. 15D, there is illustrated another view of the GUI 1500. This view is the page of FIGS. 15B-C, but with the “About” list 1516 and the “When” list 1520 expanded, and also showing the full “What” list 1524 and a collapsed expandable “Post To” list 1528. The “What” list 1524 displays the options a user may select for the type of post to submit, if a post is being submitted for the triggered event, such as a picture, social post, memo, movie, music, or audio post.

Referring now to FIG. 15E, there is illustrated another view of the GUI 1500. This view is the page of FIGS. 15B-D, but scrolled down to show the “What” list 1524 collapsed and the “Post To” list 1528 expanded. The “Post To” list 1528 allows a user to select which inner circles to allow a triggered post to be viewable from a plurality of options 1530. An expandable “Where” list 1532 is also shown, having a plurality of options 1534 for selecting where and how a triggered event is to be presented, such as on the service provider's “Highlanders” social networking platform, via another social network such as Facebook, or via other channels such as email.

Referring now to FIG. 15F, there is illustrated another view of the GUI 1500. This view is the page of FIGS. 15B-E, but scrolled down still further. There is shown an expandable “Invite To” list 1536 that shows a plurality of options 1538 for allowing a user to invite other users to respond to a triggered event, such as reacting (such as liking) a post, commenting, giving a gift, or donating money or credits. There is also an expandable “Make Action” list 1540 having a plurality of options 1542 for performing an action in response to another user responding to the triggered event, such as sending that user a greeting, sending a gift, or sending money or credits. There is shown near the bottom of the current view of the page an expandable “Recipient” list 1544 in a collapsed state.

Referring now to FIG. 15G, there is illustrated another view of the GUI 1500. This view is the page of FIGS. 15B-G, but scrolled down still further. There is shown the “Make Action” list 1540 in a collapsed state. The “Recipient” list 1544 is shown expanded to list a plurality of options 1546 for choosing a recipient for a gift, such as a purchased product or a gift of money or credits. Such recipients may include users chosen from family members, friends, or other circles, or may be a particular cause or charitable organization.

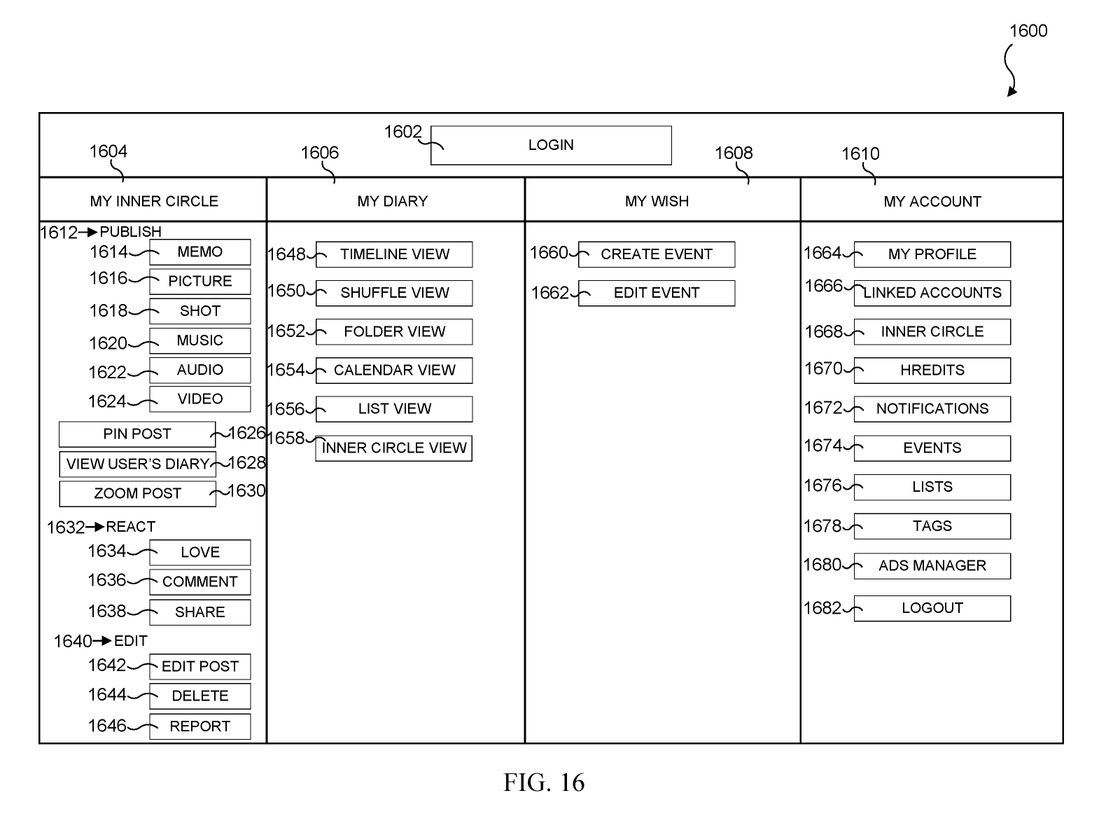

Referring now to FIG. 16, there is illustrated one embodiment of a social network platform functionality diagram 1600. The functionality includes a login process 1602. In some embodiments, login might require a username or email address and password. In other embodiments, no password may be required. In these embodiments, the user would only enter an email address to log in. Not requiring a password improves user experience by allowing them to log in quicker, and ensure security since many Internet users use the same password for many different accounts online. Without a password, the log in or sign up will occur whenever the website is visited or the application on a device is opened. The user then enters his or her email address and an email is sent to that email address, the email containing a button or hyperlink to allow the user to be redirected back to the website or application and logged in. In some embodiments, once this is done at sign up, the user device is remembered and the email address may no longer need to be entered and no emails will need to be sent to log in. If the user later uses a different device, they would receive another email before they are allowed to log in, to ensure that the user's account or device has not been stolen. This same procedure may also be done using SMS text messaging rather than email.

Further functions are divided in the diagram 1600 by type of function. There are four categories of functionality illustrated: a “My Inner Circle” category 1604, a “My Diary” category 1606, a “My Wish” category 1608, and a “My Account” category 1610. The “My Inner Circle” category 1604 has various associated functions under additional categories. A “Publish” function 1612 has additional functions associated with it, including a “Memo” function 1614, a “Picture” function 1616, a “Shot” function 1618, a “Music” function 1620, an “Audio” function 1622, and a “Video” function 1624. Each of these options under the “Publish” function 1612 allows a user to choose the type of content to be published and posted on the social networking platform.

The “My Inner Circle” category 1604 further includes a “Pin Post” function 1626, a “View User's Diary” function 1628, and a “Zoom Post” function 1630. A “React” function 1632 has additional functions associated with it to allow a user to choose how to react to another user's post. These include a “Love” function 1634, a “Comment” function 1636, and a “Share” function 1638. An “Edit” function 1640 also has additional function associated with it, so that a user can choose how to edit a post. These include an “Edit Post” function 1642, a “Delete” function 1644, and a “Report” function 1646.

The “My Diary” category 1606 includes functions for determining how a user's diary is viewed. A user's diary includes all posts saved by the user for future use. These posts may include a user's own posts, or other users' posts. These posts saved in a user's diary can also be used in created future events, such as reposting a saved post to remind other users of the post or memory. The “My Diary” category 1606 includes a “Timeline View” function 1648, which allows a user to view all saved posts on a timeline. A “Shuffle View” function 1650 allows a user to view the saved posts in a random order. A “Folder View” function 1652 allows a user to view folders categorizing the saved posts into categories created by the user or by the system. A “Calendar View” 1654 allows the user to view a calendar, with saved posts appearing on the calendar on dates for which they were originally created. A “List View” function 1656 allows a user to view all saved posts in a list. The list may be arranged in various orders, such as chronologically, by user who created the post, by popularity (such as by loves or comments), or in other ways. An “Inner Circle View” function 1658 allows a user to view saved posts categorized by inner circles. For example, a user could choose his “Family” inner circle and would only view the saved posts originally created by the users in his “Family” inner circle.

The “My Wish” category 1608 includes functions such as those described herein for creating future triggering events. The category 1608 includes, among other functions described herein, a “Create Event” function 1660 for creating new future triggering events, and an “Edit Event” function 1662 for editing previously-created future triggering events.

The “My Account” category 1610 includes functions for managing a user's account on the social networking platform. A “My Profile” function 1664 allows a user to view and edit profile details, such as contact information, login information, legacy contact information, profile pictures, wall pictures, privacy settings (such as setting who can view a user's posts), security information, personal information such as a birth date, etc. A “Linked Accounts” function 1666 allows a user to view, add, and edit the other platforms associated with the user, such as linking a user's Facebook and Twitter accounts. Linking other accounts allows a user to post on the other platforms, share posts from the Highlanders platform on the other platforms, share posts from the other platform on the Highlanders platform, and other functions. An “Inner Circle” function 1668 allows a user to view the other users who are in the user's inner circles, to edit the users in those inner circles, to add more inner circles, etc. A “Hredits” function 1670 allows a user to view the user's accumulated credits, manipulate those credits by gifting them or purchasing items, or other functions. A “Notifications” function 1672 allows a user to view notifications for the user. These notifications may be alerts that users within the user's inner circle have submitted new posts, that the user has received a gift, that the user has received a private message, that one of the user's events have triggered, etc.

The “My Account” category 1610 additionally includes an “Events” function 1674, which allows a user to view the user's created future triggered events, events of other inner circle users that have triggered, or social events that have been created and to which the user has been invited. A “Lists” function 1676 allows a user to view saved lists, including a list of saved posts/memories, quotes, events, and causes or charities the user has saved. A “Tags” function 1678 allows a user to view saved posts by tags, search for other posts by tags, or other functions associated with tags. An “Ads Manager” function 1680 allows a user to view ads created for the social networking platform. In certain embodiments, this function is meant for third-party partners 112 only and would not be visible to normal users. In these embodiments, the third-party partners 112 could buy ad space and submit ads to be viewed on the site, generating revenue for the third-party partner 112 as well as generating credits for users who generate traffic to the ads. The third-party partners 112 may also provide ads on the platform for goods and services they are offering to users that the users can purchase and gift to other users. A “Logout” function 1682 allows a user to logout the user's account.

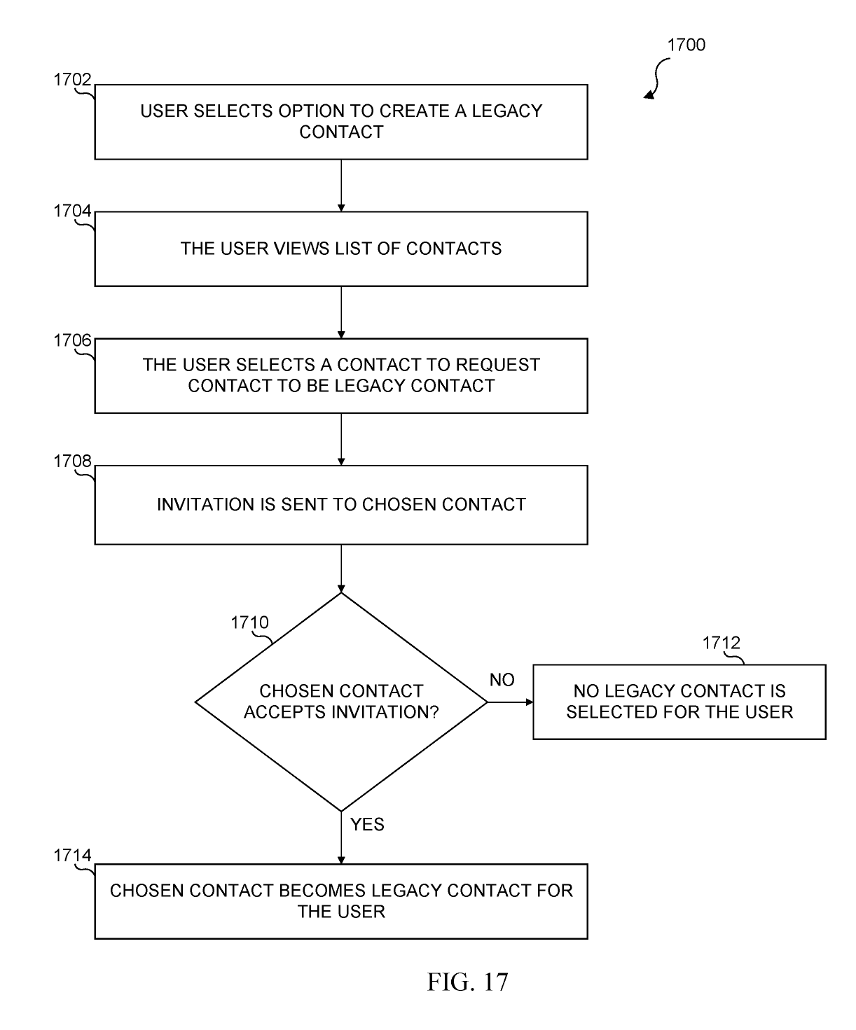

Referring now to FIG. 17, there is illustrated a flowchart of one embodiment of a legacy contact selection process 1700. A legacy contact is another user chosen by a user to issue a notification that the user is now deceased. The process begins at step 1702 where a user selects an option to create a legacy contact. At step 1704, the user views a list of the user's contacts. At step 1706, the user selects a contact to request that the contact be the user's legacy contact. In response, at step 1708, an invitation is sent to the chosen contact, requesting that the contact become the user's legacy contact.

The invitation sent to the chosen contact may include a system-generated message explaining what it means to become a legacy contact, such as explaining that it is an important role and that, if the invitation is accepted, the chosen contact will have the responsibility of notifying the platform that the user is now deceased. The invitation may also include a personal message entered by the user before the invitation is sent. During the time between when the invitation is sent to the chosen contact and when a response is received from the chosen contact, the user may be notified, when going back into the legacy contact selection option, that the sent invitation is still awaiting a response. If the user feels that the chosen contact is taking too long to respond, the user may choose to withdraw the invitation. The chosen contact may be presented with various responses the chosen contact can choose for responding to the invitation, such as an accept response or a reject response. If the invitation is rejected, the chosen contact may include with the rejection a message stating the reasons that the chosen contact does not wish to become the user's legacy contact. There may also be an option allowing the chosen contact to wait to decide later, leaving the invitation open until the chosen user decides to accept or reject the invitation, or the user decides to withdraw the invitation.

At decision block 1710, it is determined whether the chosen contact has accepted the invitation. If not, the process 1700 flows to step 1712, where no legacy contact is selected for the user at this time. Of course, the user may start the legacy contact selection process again if the user wishes to select a different contact to be the legacy contact. If the chosen user accepts the invitation at decision block 1710, the process flow to step 1714, where the chosen contact becomes the user's legacy contact.

Referring now to FIG. 18, there is illustrated a flowchart of one embodiment of a legacy contact initiated deceased status notification process 1800. The process 1800 begins at step 1802 where a user is now deceased. At step 1804, the legacy contact for the deceased user sends a notification to the system that the user has passed away. Additional security measures may be implemented to ensure that the deceased user is in fact deceased and that the legacy contact is not mistaken or is not otherwise attempting to notify the system that the user is deceased when such is not true. The process flows to decision block 1806 where it is determined if an additional user verification option has been set. The deceased user may have set up this option in addition to creating a legacy contact, in order to ensure that additional security is implemented to avoid a false notification of the user's death to the system. If this option is set, the process flows to step 1808, where the system waits for additional users other than the legacy contact to verify that the deceased user is actually deceased. The number of additional users may be set by the deceased user when creating the user's death notification options, such as requiring that five additional users verify the user's death before the user's status is changed in the system. The system may send a message to these users after the notification from the legacy contact is received, asking the additional users to verify the user's death. After receiving verification from the additional users, or if at decision block 1806 it is determined that the additional user verification option was not set, the process flows to decision block 1810. At decision block 1810, it is determined if an inactivity period verification option has been set. This option creates a selected period of time that the system must wait before attempting to switch the status of the user to deceased, such as 30 days. This allows the user time to notify the system that a potential change in the status of the user was submitted in error. If this option was set, the process flows to step 1812, where the system waits the predetermined amount of time set for the inactivity period verification option. If the user reports that the user is still alive during this time, the process 1800 would be aborted. Once the predetermined amount of time has passed without word from the user, or if at decision block 1810 it is determined that the inactivity period verification option was not set, the process flows to decision block 1814. At decision block 1814 it is determined whether a paper certificate verification option has been set. This verification option requires that, for the status of the user to be changed to deceased, paper documentation of the user's death must first be received by the system or its operators. In some embodiments, electronic copies of the paperwork may also be accepted. If the option is set, the process flows to step 1816, where the system waits to receive the documents verifying that the user is now deceased. In some embodiments, the system may abort the process 1800 if too much time passes during this step. Once the documents are received, or if at decision block 1814 it is determined that the paper certificate verification option was not set, the process flows to step 1818.

At step 1818, the system removes any legacy contact status for the deceased user. This is done so that, if the deceased user was the legacy contact for any other users, those other users would not be relying on a user who is now deceased to notify the system when they become deceased. If the deceased user is removed as the legacy contact for any other users, those other users may be sent a message indicating that their legacy contact has been removed, and stating the reason for the removal. They may also be advised to choose a new legacy contact. At step 1820, events created for the deceased user that are set to trigger after the user's death are activated. At step 1822, the now activated events trigger as appropriate according to the parameters set for the events. This allows for the deceased user's digital presence and legacy to remain active on the system, reminding users in the deceased user's inner circle of post/memories of the deceased user, sending content, gifts, donations or other items to users in response to past life events of the deceased user (the deceased user's death or birth day, for example), in response to life events of users in the deceased user's inner circles, or in response to other triggers described herein, and allowing users in the deceased user's inner circle to view the page for the deceased user.

Referring now to FIG. 19, there is illustrated a diagrammatic view of one embodiment of an event storage and event execution system 1900. When a user (User1 in this example) passes away, a legacy contact 1902 sends a deceased notification 1904 to a server 1906, indicating that the user that the legacy contact was responsible is now deceased. The server 1906 stores information on users of the social media platform, events created by and associated with those users, and other information. The server 1906 may have a database established for facilitating the storage of this information and the relational characteristics of the information.

As shown in FIG. 19, the server 1906 has stored a user table 1908, which in this example includes a plurality of information on User1. It will be understood that the information stored on the server 1906 may not be stored in table or spreadsheet format as shown in FIG. 19, and the tables shown are for visual and explanatory purposes. A relational database on the server 1906 may be structured however necessary to create the appropriate relationships between the stored information. Such information may include a unique ID for the user, the user's name, user contact information, etc. The table 1908 may also include a legacy flag entry 1910. The legacy flag is a flag for marking individual users with an indication as to whether the user is still alive or has passed away. In some embodiments, the flag may be represented by single character, such as ‘A’ for “Alive” and ‘P’ for “Passed.” In some embodiments, the legacy flag may be implemented as a boolean variable/expression, such as “isAlive=True.” In some embodiments, when the legacy contact for a user sends the notification to the server 1906 that a user has passed, the legacy flag entry 1910 may be automatically updated to indicate that the user is deceased. In other embodiments, a set amount of time may be required to pass before the legacy flag entry 1910 is updated, to ensure that the notification was not sent in error. This may be done by requiring, in some embodiments, that others besides the legacy contact verify that the user has indeed passed. In some embodiments, the legacy contact may have to send official documentation of the user's death to the service provider 106 before a legacy flag can be changed.

Stored in relation to the user table 1908 is an events table 1912. The events table 1912 stores events created by the associated user. In this example, the events table 1912 is associated with User1. The events table 1912 includes a plurality of events previously created by User1 before the death of User1. There is shown a first event 1914 having an event name of “The Day I Die.” The first event 1914 has a status of “Inactive,” which indicates that the trigger for the event has already taken place, and the event is not set to repeat, or, if the event was set to repeat, the parameters for the repetition of the event were set in a way where the event will no longer trigger, as those parameters cannot be met again. For example, an event might be created to a give a gift to a family member every year until that family member turns 18. Once that family member turns 18, the event would be changed to inactive. A trigger for the first event 1914 is indicated as being when the server 1906 receives the notification 1904 from the legacy contact 1902. Since the notification 1904 was received, the first event 1914 already has triggered and the first event 1914 has been set to “Inactive.” The first event 1914 also lists under a “Recipients” column that the recipients of the event are all users in all of User1's circles.

An “Action” column lists the action type to be taken in response to the trigger, with the listed action also being linked to an action table. In this example, the first event 1914 includes a “Post” action, defined by a Post Data table 1916. The Post Data table 1916 includes information on the post, including content information. There is shown in the Post Data table 1916 a unique post ID, where every post created has such a unique ID, to enable the system to easily retrieve and reference the post. The Post Data table 1916 also includes a caption entry, which stores a caption for the post, which is “Farewell” in the example shown in FIG. 19. A message entry is also included, which forms the text body of the post, with the message being “Goodbye Everyone” in this example. A media entry is also included in the Post Data Table 1916. The media entry lists a URL, a local storage location, or some other location identification for media such as audio, video, a picture, or other media. A post may have multiple media entries if more than one item of media is to be included in the post. In this example, the media entry has a URL for a video, with the URL being a location on the website or other location for the service provider's platform. The service provider's platform may allow users to save media when they create a post, even when the post is to be sent later as a triggered event, with the media being stored on the server 1906 or other locations accessible by the platform.

The Post Data table 1916 also includes a tags entry that includes tags set by the user who created the event and post, with this example showing “Death,” “Farewell,” and “Video” as the tags. A reaction entry is also included in the Post Data Table 1916. This reaction entry indicates whether the user has set up the event to solicit a reaction from users who view the post, the type of reaction solicited, and whether an automatic response should be sent to users who react. In this example, the reaction entry reads “Y:Comment:Response—“Always With You,” with the ‘Y’ (Yes) indicating that a reaction solicitation has been set up, with “Comment” indicating that the type of reaction to be solicited is a comment from users who view the post, and with “Response—‘Always With You’” indicating that if users comment on the post, an automatic response from User1 stating “Always With You” will be sent to the commenting user. The Post Data table 1916 also includes a give credits entry, indicating whether credits accumulated by User1 should be given to other users. It will be understood that other information may also be included in the post data table 1916, such as other post content and information on formatting for the post.

A second event 1918 is also shown in the events table 1912. The second event 1918 is titled “Son's Birthday,” has a status of “Active,” is directed to a single recipient (the user ID for User1's son), and is triggered by a date to send a gift to the recipient. The trigger date may be stored in some embodiments as a timestamp. In some embodiments, trigger conditions may be checked for at set intervals by the server 1906 to save resources and processing power. For example, the server 1906 may only check for trigger conditions every hour. In that case, for timestamp triggers, the server 1906 may search for all timestamp trigger conditions stored in association with active events that range in time between the last trigger condition check (one hour previous) and the current check. Timestamps may also be searched by only month and day, allowing for birthdays to be triggered every year. For other trigger conditions, such as interests triggers that use web feeds, the server 1906 may periodically request content from web feeds that users link to an event, such as RSS feeds or via website APIs, to determine if that web feed has new content. If so, the new content may be searched for keywords or other indicators as appropriate for the specified trigger.

The action to be taken when the second event 1918 triggers is to give a gift. Information relating to the gift is stored in a Gift Data table 1920. The Gift Data table 1920 may include a marketplace ID, which is a unique ID for a marketplace partner of the social networking platform. For example, the online store Amazon may be a partner, with its marketplace having a unique ID. There is also shown in the Gift Data table 1920 a product ID, which is a unique ID for the product chosen by User1, and is the product User1 intends to give his son on his son's birthday. A delivery entry lists the method of delivery for the product. In this example, the delivery option is the email of user ID 34259, the sons and recipient of the gift event. Media may also be included in the delivery (such as included in an email containing the gift) or may also be sent as a social media post to the recipient. In this example, a video stored locally on the server 1906 is to be sent to the recipient.

A third event 1922 is included in the events table 1912. The third event 1922 is an event titled “Yankees Win It,” is set to “Active,” and is triggered by a selected RSS feed, which, if polled content from that RSS feed contains the phrase “Yankees Win World Series,” the event is triggered. The RSS feed content may not require the exact phrase, as parameters may be placed for searching for alternatives or derivatives of the phrase. The third event 1922 also shows that it is to be directed towards two different recipients, indicated by the recipients' user IDs, with action to be taken being a device action, which is an action that alters a connected device or causes the connected device to perform some action. Typically the connected device would be added either by User1 or by the recipients of the event, allowing User1 to have selected their devices when creating the event.

A Device Action table 1924 is associated with the third event 1922. The Device Action table 1924 lists the device IDs for the devices to be activated. A device ID 23824 is listed as being a Nest thermostat device, having an IPv6 address for allowing the server 1906 to connect to the device, and an action to perform. In this example, the action to be taken is to illuminate the Nest thermostat device so that it lights up when the Yankees win the World Series. A second device ID 13478 is listed as being a device running the Android operating system. An IPv6 address is also listed for the Android device, with the action to be taken being activating the default ringtone on the device when the Yankees win the World Series. It will be understood that the relational data described with respect to FIG. 19 may include data necessary to perform any of the types of events described herein.

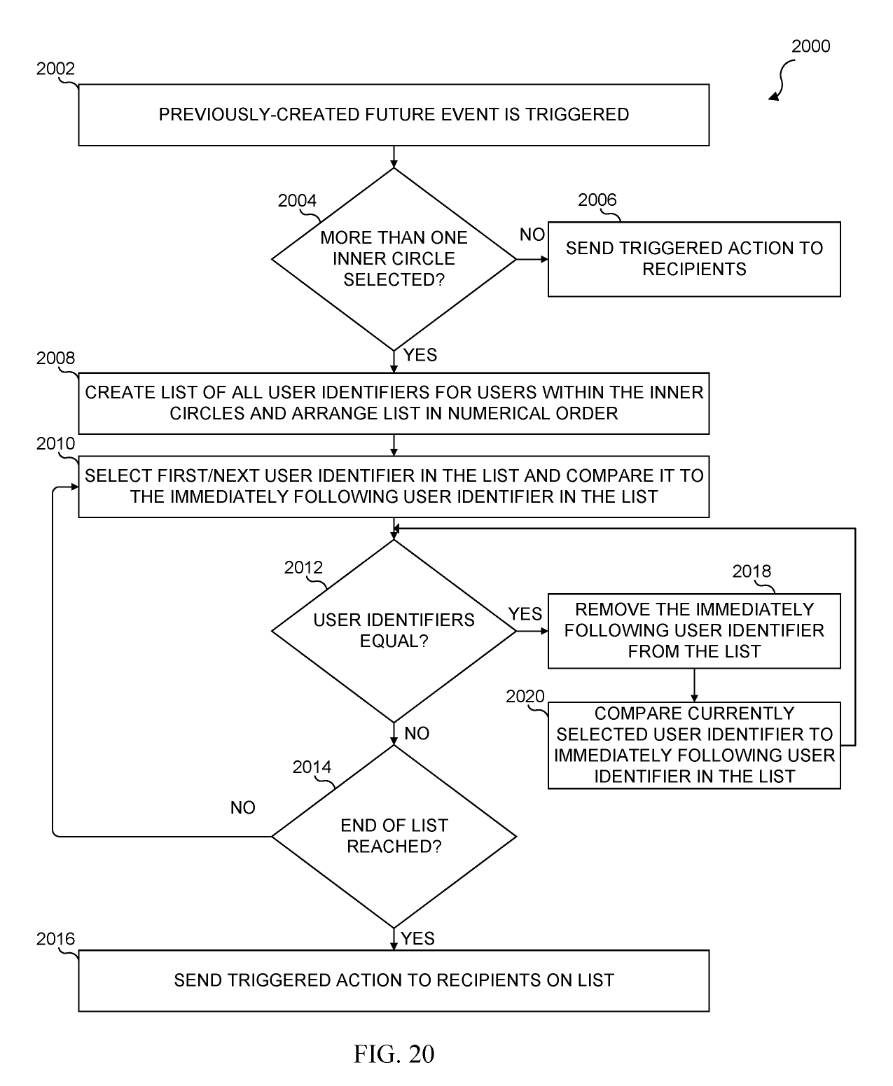

Referring now to FIG. 20, there is illustrated a flowchart of one embodiment of a duplicate post avoidance process 2000. The process 2000 begins at step 2002, where a previously-created future event is triggered. At decision block 2004, it is determined whether more than one inner circle is selected as the recipient for the future event. If not, the process ends at step 2006 where the triggered action is sent to the recipients. However, if more than one inner circle is determined to be selected for the event at decision block 2004, the process moves on to step 2008. At step 2008, a list is created of all the user identifiers for the users within the inner circles selected for the triggered event, and the list is arranged in numerical order by user identifier. At step 2010, the first user identifier in the list is compared to the immediately following user identifier in the list (the second identifier in this case when the first identifier has been selected). At decision block 2012, it is determined whether the selected user identifier and the immediately following user identifier are the same number. If not, the process flows to decision block 2014 where it is determined if the end of the list has been reached. If so, the process ends at step 2016, where the triggered action is sent to the recipients or user identifiers on the list.

However, if at decision block 2014 it is determined that the end of the list has not been reached, the process flows back to step 2010, where the next user identifier in the list is selected and compared to the user identifier immediately following the selected next user identifier. If at decision block 2012 it is determined that the compared user identifiers are equal, the process flows to step 2018 where the user identifier immediately following the selected user identifier is removed from the list. The process then flows to step 2020, where the currently selected user identifier, the one selected in step 2010, is compared to the new immediately following user identifier that has replaced in the list the user identifier removed in step 2018. The process then flows to back to decision block 2012 to determine whether the currently selected user identifier is equal to the new immediately following user identifier. If so, the process will flow to step 2018 again to remove the new immediately following user identifier from the list, or, if not, the process continues on to decision block 2014 again. Thus, this process allows for the removal of all duplicate user identifiers from the list, in order to avoid sending the triggered event to the same user more than once, such as posting the same post more than once on a user's feed.

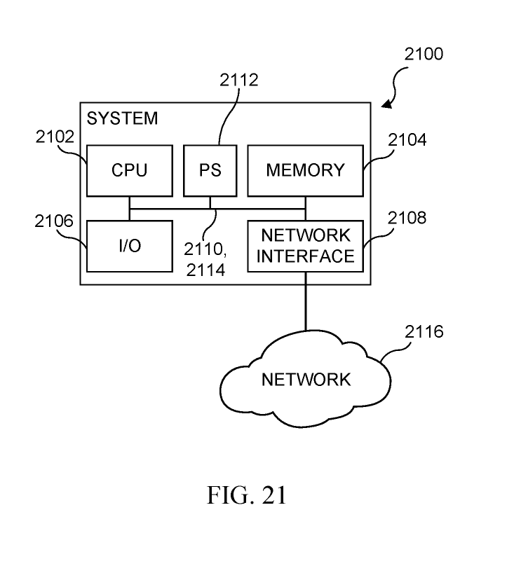

Referring to FIG. 21, one embodiment of a system device 2100 is illustrated. The system device 2100 is one possible example of a device used by an end user 108, a device used by the service provider 106, or one possible example of the remote server 102. Embodiments include cellular telephones (including smart phones), personal digital assistants (PDAs), netbooks, tablets, laptops, desktops, workstations, telepresence consoles, and any other computing device that can communicate with another computing device using a wireless and/or wireline communication link. Such communications may be direct (e.g., via a peer-to-peer network, an ad hoc network, or using a direct connection), indirect, such as through a server or other proxy (e.g., in a client-server model), or may use a combination of direct and indirect communications. It is understood that the device may be implemented in many different ways and by many different types of systems, and may be customized as needed to operate within a particular environment.

The system 2100 may include a controller (e.g., a central processing unit (“CPU”)) 2102, a memory unit 2104, an input/output (“I/O”) device 2106, and a network interface 2108. The components 2102, 2104, 2106, and 2108 are interconnected by a transport system (e.g., a bus) 2110. A power supply (PS) 2112 may provide power to components of the computer system 2100, such as the CPU 2102 and memory unit 2104, via a power system 2114 (which is illustrated with the transport system 2110 but may be different). It is understood that the system 2100 may be differently configured and that each of the listed components may actually represent several different components. For example, the CPU 2102 may actually represent a multi-processor or a distributed processing system; the memory unit 2104 may include different levels of cache memory, main memory, hard disks, and remote storage locations; the I/O device 2106 may include monitors, keyboards, and the like; and the network interface 2108 may include one or more network cards providing one or more wired and/or wireless connections to a network 2116. Therefore, a wide range of flexibility is anticipated in the configuration of the computer system 2100.

The system 2100 may use any operating system (or multiple operating systems), including various versions of operating systems provided by Microsoft (such as WINDOWS), Apple (such as Mac OS X), UNIX, and LINUX, and may include operating systems specifically developed for handheld devices, personal computers, servers, and embedded devices depending on the use of the system 2100. The operating system, as well as other instructions, may be stored in the memory unit 2104 and executed by the processor 2102. For example, the memory unit 2104 may include instructions for performing some or all of the methods described herein.

It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for maintaining a digital presence of deceased users, comprising:
storing, on a server, user information pertaining to a user;
storing on the server one or more future events, each of the one or more future events including:
an event identifier;
an event trigger, wherein the event trigger is a predefined parameter that must occur for a future event to be triggered;
an event status initially set to an inactive status, wherein the inactive status indicates that the event will not occur, even if the event trigger occurs;
a stored action, wherein the stored action is an action to be taken by the server when the event is in an active status and when the event trigger occurs; and
one or more stored destinations for directing the stored action;
receiving at the server a notification to activate the one or more future events;
switching the event status of each of the one or more future events to the active status; and
executing the one or more future events based on the event trigger associated with each of the one or more future events.

2. The method of claim 1, wherein the event trigger is a specified date.

3. The method of claim 1, wherein the event trigger is triggered by analyzing content of web feeds retrieved by the server for pre-defined keywords or phrases.

4. The method of claim 1, wherein the event trigger is triggered by the server receiving a notification of a change in status of a remote device.

5. The method of claim 1, wherein the stored action includes content to be posted on a web-based social network, and formatting parameters for the content.

6. The method of claim 5, further comprising:
determining whether execution of the stored action will result in the content being directed to more than one group of users of the social network;
arranging in a list a plurality of unique identifiers in numerical order, each of the unique identifiers being associated with a specific user among the more than one group of users of the social network;
selecting, starting from the beginning of the list, a next user identifier in the list;
comparing the next user identifier with a user identifier immediately following the next user identifier;
determining if the next user identifier and the user identifier immediately following the next user identifier are equal;
removing, if the next user identifier and the user identifier immediately following the next user identifier are equal, the immediately following user identifier from the list;
determining if the end of the list has been reached;
repeating, if the end of the list has not been reached, the selecting, comparing, determining, removing, and determining steps; and
directing the content to the user identifiers contained within the list upon execution of the stored action.

7. The method of claim 1, wherein the stored action includes sending a text, email, or phone message to a user.

8. The method of claim 1, wherein the stored action for at least one of the one or more future events includes parameters for altering the status of a remote device.

9. The method of claim 8, further comprising:
assigning the remote device with a unique identifier;
storing at the server the unique identifier;
storing a device address for the remote device, wherein the device address is addressable over a network;
storing a device action specific to the type of device of the remote device; and
wherein executing the stored action for the at least one of the one or more future events includes performing the device action to alter the status of the remote device.

10. The method of claim 1, wherein the notification to activate the one or more future events is an electronic transmission received by the server from a user responsible for notifying the server when another user is now deceased.

11. A system for maintaining a digital presence of deceased users, comprising:
a processor; and
a memory coupled to the process, the memory containing computer executable instructions for:
storing, on a server, user information pertaining to a user;
storing on the server one or more future events, each of the one or more future events including:
an event identifier;
an event trigger, wherein the event trigger is a predefined parameter that must occur for a future event to be triggered;
an event status initially set to an inactive status, wherein the inactive status indicates that the event will not occur, even if the event trigger occurs;
a stored action, wherein the stored action is an action to be taken by the server when the event is in an active status and when the event trigger occurs; and
one or more stored destinations for directing the stored action;
receiving at the server a notification to activate the one or more future events;
switching the event status of each of the one or more future events to the active status; and
executing the one or more future events based on the event trigger associated with each of the one or more future events.

12. The system of claim 11, wherein the event trigger is a specified date.

13. The system of claim 11, wherein the event trigger is triggered by analyzing content of web feeds retrieved by the server for pre-defined keywords or phrases.

14. The system of claim 11, wherein the event trigger is triggered by the server receiving a notification of a change in status of a remote device.

15. The system of claim 11, wherein the stored action includes content to be posted on a web-based social network, and formatting parameters for the content.

16. The system of claim 15, further comprising instructions for:
determining whether execution of the stored action will result in the content being directed to more than one group of users of the social network;
arranging in a list a plurality of unique identifiers in numerical order, each of the unique identifiers being associated with a specific user among the more than one group of users of the social network;
selecting, starting from the beginning of the list, a next user identifier in the list;
comparing the next user identifier with a user identifier immediately following the next user identifier;
determining if the next user identifier and the user identifier immediately following the next user identifier are equal;
removing, if the next user identifier and the user identifier immediately following the next user identifier are equal, the immediately following user identifier from the list;
determining if the end of the list has been reached;
repeating, if the end of the list has not been reached, the selecting, comparing, determining, removing, and determining steps; and
directing the content to the user identifiers contained within the list upon execution of the stored action.

17. The system of claim 11, wherein the stored action includes sending a text, email, or phone message to a user.

18. The system of claim 11, wherein the stored action for at least one of the one or more future events includes parameters for altering the status of a remote device.

19. The system of claim 18, further comprising instructions for:
assigning the remote device with a unique identifier;
storing at the server the unique identifier;
storing a device address for the remote device, wherein the device address is addressable over a network;
storing a device action specific to the type of device of the remote device; and
wherein executing the stored action for the at least one of the one or more future events includes performing the device action to alter the status of the remote device.

20. The system of claim 11, wherein the notification to activate the one or more future events is an electronic transmission received by the server from a user responsible for notifying the server when another user is now deceased.
